(19) United States
(12) Patent Application Publication
(10) Pub. No.: US 2026/0302971 A1
(43) Pub. Date: Oct. 1, 2026

(54) LIGHTWEIGHT TRIBOELECTRIC DEVICE, METHOD OF GENERATING A FLOW OF ELECTRIC CHARGES AND VEHICLE USING SAME

(71) Applicant: THE ROYAL INSTITUTION FOR THE ADVANCEMENT OF LEARNING/MCGILL UNIVERSITY, Montréal (CA)

(72) Inventors: Abdolhamid Akbarzadeh SHAFAROUDI, Montreal (CA); Haoyu CHEN, Sainte-Anne-De-Bellevue (CA); Jiahao SHI, Sainte-Anne-De-Bellevue (CA)

(21) Appl. No.: 19/514,230

(22) PCT Filed: Aug. 30, 2024
(86) PCT No.: PCT/CA2024/051130

§ 371 Date: Feb. 25, 2026

Related U.S. Application Data
(60) Provisional application No. 63/535,929, filed on Aug. 31, 2023.

(51) Int. Cl. H02N 1/04

(52) U.S. Cl. CPC H02N 1/04

(57) ABSTRACT

There is described a triboelectric device. The triboelectric device generally having: a resilient structure having a deformation plane, and a plurality of hollow cells having internal walls having a cross-sectional shape extending along a respective cell axis My perpendicular to the deformation plane, the internal walls defining a cavity thereinside, and having first and second curved surfaces distributed around the cavity and facing the cavity; and a triboelectric circuit having a first electrode assembly covering the first curved surfaces, a second electrode assembly covering the second curved surfaces, the first and second electrode assemblies electrically insulated from one another; wherein, when the resilient structure is deformed along the deformation plane, the first and second electrode assemblies perform a movement relative to one another thereby creating a flow of electric charges across the triboelectric circuit.

### FIELD

The improvements generally relate to electrical devices and more specifically to electrical devices capable of generating a flow of electric charges via triboelectric effect.

### BACKGROUND

The triboelectric effect describes electric charge transfer between two objects when they move (e.g., contact, slide) relative to one another. It can occur with different materials, such as a balloon on a hairy head, or between two objects of the same material. Static electricity is generally a consequence of the triboelectric effect when the electrical charges stay on one or both of the two objects and is not conducted away. In some circumstances, it can be desirable to have these electrical charges conducted across an electrical circuit for later use. Although existing triboelectric devices are satisfactory to a certain degree, there remains room for improvement.

### SUMMARY

In this disclosure, there is described a triboelectric device having a resilient structure which can be elastically deformed within a deformation plane under loading and which can take its original shape after unloading. The resilient structure has hollow cells adjacent to one another. The hollow cells each have an internal wall with a cross-sectional shape extending along a respective cell axis perpendicular to the deformation plane. The internal wall of a corresponding hollow cell defines a cavity thereinside, and has first and second curved surfaces distributed around and facing the cavity. The triboelectric device has a triboelectric circuit with a first electrode assembly covering the first curved surfaces, and a second electrode assembly covering the second curved surfaces. The first and second electrode assemblies are electrically insulated from one another. As such, when the resilient structure is deformed along the deformation plane, the first and second electrode assemblies perform a movement relative to one another thereby creating a flow of electric charges across the triboelectric circuit via triboelectric effect. It was found that by covering the curved surfaces of the internal walls of the hollow cells, sometimes diametrically opposite to one another, larger relative movements of the first and second electrode assemblies can be achieved, thereby increasing the amount of electrical charges created for a similar deformation of the resilient structure. In some embodiments, the resilient structure has a negative Poisson's ratio, which is also referred to as an auxetic construction, such that when the resilient structure is stretched along a given orientation, the resilient structure expands in an orientation perpendicular to the given orientation, and vice versa. Using such auxetic construction can also favour larger relative movements of the first and second electrode assemblies can be achieved.

In accordance with a first aspect of the present disclosure, there is provided a triboelectric device comprising: a resilient structure having a deformation plane, and a plurality of hollow cells having internal walls having a cross-sectional shape extending along a respective cell axis perpendicular to the deformation plane, the internal walls defining a cavity thereinside, and having first and second curved surfaces distributed around the cavity and facing the cavity; and a triboelectric circuit having a first electrode assembly covering the first curved surfaces, a second electrode assembly covering the second curved surfaces, the first and second electrode assemblies electrically insulated from one another; wherein, when the resilient structure is deformed along the deformation plane, the first and second electrode assemblies perform a movement relative to one another thereby creating a flow of electric charges across the triboelectric circuit. In some embodiments, the first and second curved surfaces differ in circumferential positioning from one hollow cell to another. In those embodiments, the orientation of the first and second electrode assemblies in each of the hollow cells can differ, thereby allowing electrical charges to be created when the resilient structure is deformed into more than one orientation parallel of the deformation plane.

Further in accordance with the first aspect of the present disclosure, the first and second curved surfaces can for example differ in circumferential positioning from one hollow cell to another.

Still further in accordance with the first aspect of the present disclosure, the resilient structure can for example be auxetic.

Still further in accordance with the first aspect of the present disclosure, the relative movement of the first and second electrode assemblies can for example include a rotational movement.

Still further in accordance with the first aspect of the present disclosure, the resilient structure can for example have a first lateral side exposing first openings of the hollow cells, and a second lateral side exposing second openings of the hollow cells, the second openings opposite to the first openings.

Still further in accordance with the first aspect of the present disclosure, the first electrode assembly can for example have a plurality of first flaps inserted into the hollow cells via the first openings and the second electrode assembly having a plurality of second flaps inserted into the hollow cells via the second openings.

Still further in accordance with the first aspect of the present disclosure, the first and second electrode assemblies can for example have an electrically conductive layer and an electrically insulating layer covering the electrically conductive layer, the electrically insulating layers of the first electrode assemblies facing the electrically insulating layers of the second electrode assemblies across the cavities.

Still further in accordance with the first aspect of the present disclosure, the electrically insulating layer of the first electrode assembly can for example be made of a first electrically insulating material, and the electrically insulating layer of the second electrode assembly is made of a second electrically insulating material different from the first electrically insulating material.

Still further in accordance with the first aspect of the present disclosure, the first electrically insulating material can for example be polyethylene terephthalate (PET) and the second electrically insulating material is polytetrafluoroethylene (PTFE).

Still further in accordance with the first aspect of the present disclosure, the electrically conductive layer can for example be a sheet of metallic material.

Still further in accordance with the first aspect of the present disclosure, the hollow cells can for example be arranged in a tessellation made integral to the resilient structure.

Still further in accordance with the first aspect of the present disclosure, the resilient material can for example be made of polypropylene (PP).

Still further in accordance with the first aspect of the present disclosure, the first and second electrode assemblies can for example be laminated onto a respective one of the first and second curved surfaces.

Still further in accordance with the first aspect of the present disclosure, the first electrode assembly can for example cover a third curved surface of the internal wall, and the second electrode assembly covers a fourth curved surface of the internal wall, and wherein the first, second, third and fourth curved surfaces are distributed around the cavity, facing the cavity and interspersed with one another.

Still further in accordance with the first aspect of the present disclosure, the cross-sectional shape can for example be selected from a group consisting of: a triangular-like shape, a circular-like shape, an ovoid-like shape, a quadrilateral-like shape, a hexagonal-like shape, and a horseshoe-like shape.

Still further in accordance with the first aspect of the present disclosure, the flow of charges can for example be indicative of at least one of an amplitude and a direction of the deformation imparted on the resilient structure in the deformation plane.

Still further in accordance with the first aspect of the present disclosure, the flow of charges can for example provide an electrical current above an electrical current threshold.

In accordance with a second aspect of the present disclosure, there is provided a method of generating a flow of electric charges using a triboelectric device, the triboelectric device having a resilient structure having a deformation plane, and a plurality of hollow cells having internal walls having a cross-sectional shape extending along a respective cell axis perpendicular to the deformation plane, the internal walls defining a cavity thereinside, and having first and second curved surfaces distributed around the cavity and facing the cavity, the method comprising: a triboelectric circuit providing a first electrode assembly snugly covering the first curved surfaces, and a second electrode assembly snugly covering the second curved surfaces; the resilient structure electrically insulating the first and second electrode assemblies electrically insulated from one another; and while deforming the resilient structure along the deformation plane, said deforming including moving the first and second curved surfaces of the hollow cells relative to one another, creating a flow of electric charges across the triboelectric circuit.

Further in accordance with the second aspect of the present disclosure, the first and second curved surfaces can for example differ in circumferential positioning from one hollow cell to another.

Still further in accordance with the second aspect of the present disclosure, the resilient structure can for example be such that said deforming causes the resilient structure to become thicker perpendicular to an exerted deformation force when stretched and to become thinner perpendicular to the exerted deformation force when compressed.

Still further in accordance with the second aspect of the present disclosure, the method can for example further comprise a controller having a processor and a non-transitory memory having stored thereon instructions which when executed by the processor perform the steps of: determining at least one of an amplitude and a direction of said deforming of the resilient structure.

In accordance with a third aspect of the present disclosure, there is provided a vehicle comprising: a body, a displacement mechanism, and a resilient structure connecting the body to the displacement mechanism, the resilient structure having a deformation plane intersecting with the body and the displacement mechanism, and a plurality of hollow cells having internal walls having a cross-sectional shape extending along a respective cell axis perpendicular to the deformation plane, the internal walls defining a cavity thereinside, and having first and second curved surfaces distributed around the cavity and facing the cavity; and a triboelectric circuit having a first electrode assembly covering the first curved surfaces, a second electrode assembly covering the second curved surfaces, the first and second electrode assemblies electrically insulated from one another.

Further in accordance with the third aspect of the present disclosure, the first and second curved surfaces differ in circumferential positioning from one hollow cell to another.

All technical implementation details and advantages described with respect to a particular aspect of the present invention are self-evidently mutatis mutandis applicable for all other aspects of the present invention.

It is intended that although the illustrated triboelectric circuits, and thus their first and second electrode assemblies, are based on a contact-separation architecture in which a gap (e.g., an air gap) extends between the first and second electrode assemblies, any other suitable triboelectric architectures can be used. In any architecture used, the movement of the first and second electrode assemblies modify a volume or shape of the space extending therebetween and thus creates a flow of electrical charges in the first and second electrode assemblies.

In this disclosure, the term “resilient material” is meant to encompass any material which can absorb energy when it is deformed elastically, and release that energy upon unloading. In other words, the resilient material can be deformed by receiving a deforming force and then go back to its original shape when the deforming force is no longer applied.

Many further features and combinations thereof concerning the present improvements will appear to those skilled in the art following a reading of the instant disclosure.

### DESCRIPTION OF THE FIGURES

In the figures,

FIG. 1 is an oblique view of an example of a triboelectric device having a resilient structure with hollow cells and a triboelectric circuit, in accordance with one or more embodiments;

FIG. 2A includes an oblique and exploded view of an example of a triboelectric device, showing a resilient structure, a first electrode assembly on the left of the resilient structure and a second electrode assembly on the right of the resilient structure, an assembled view of the triboelectric device, and a cross-sectional view of the triboelectric device, showing the first and second electrode assemblies spaced apart by an air gap, in accordance with one or more embodiments;

FIG. 2B is a top plan view of the triboelectric device of FIG. 2A, emphasizing an auxetic behaviour which shrinks the resilient structure along the x orientation upon applying a loading force onto the resilient structure along the y orientation, in accordance with one or more embodiments;

FIG. 2C includes top plan views of different examples of triboelectric devices, including angle-changing constructions, distance-changing constructions and mixed-type constructions, in accordance with one or more embodiments;

FIG. 2D is an exploded view of an example electrode assembly used in the triboelectric devices of FIG. 2C, in accordance with one or more embodiments;

FIG. 3A is a top plan view of electrode assemblies made of different insulating materials, in accordance with one or more embodiments;

FIG. 3B is a schematic and partial view of an example triboelectric device made using the electrode assemblies of FIG. 3A, in accordance with one or more embodiments;

FIG. 3C is a graph showing the open-circuit voltage of the triboelectric devices made using different combinations of the electrode assemblies of FIG. 3A, in accordance with one or more embodiments;

FIG. 3D includes images of different material film samples and experimental setups used to perform tensile tests on the material film samples, and graphs showing stress-strain results of tensile tests for PP, PET-copper film, and PTFE-copper film, in accordance with one or more embodiments;

FIG. 4 includes graphs showing stress as a function of strain for triboelectric devices of different constructions under cyclic loadings, in accordance with one or more embodiments;

FIG. 5A is a schematic view showing a cycle for the maximized energy output of an example triboelectric device, with the center trapezoidal area denoting the theoretical upper threshold of the energy output, and the dash curves denoting the possible CMEO voltage-charge cycles with finite external resistances, in accordance with one or more embodiments;

FIG. 5B is a schematic view of example triboelectric devices being deformed and undeformed, in accordance with one or more embodiments;

FIG. 5C is a schematic view of geometrical models for different constructions of the triboelectric device, including the angle-changing construction, the distance-changing construction, and the mixed-type construction, in accordance with one or more embodiments;

FIG. 5D includes top plan views of triboelectric devices having different constructions, showing a categorization based on the orientation of the general movement of different pairs of first and second electrode assemblies, in accordance with one or more embodiments;

FIG. 5E includes geometrical models for some example triboelectric devices, in accordance with one or more embodiments;

FIG. 6A includes graphs showing open-circuit voltage, short-circuit current, reaction force and displacement for triboelectric devices of different constructions, in accordance with one or more embodiments;

FIG. 6B includes FEM simulations showing electric potential contours and deformation modes for the triboelectric devices of FIG. 6A under a compressive strain −0.25 (Scale bar: 10 mm), in accordance with one or more embodiments;

FIG. 6C includes graphs comparing the open-circuit voltage and stress-strain curves obtained by FEM and experimentations for the triboelectric devices of FIG. 6A, in accordance with one or more embodiments;

FIG. 7A is a graph showing numerical and analytical results for the mechanical and electrical performance of triboelectric devices of different constructions, in accordance with one or more embodiments;

FIG. 7B is a graph showing effective Poisson's ratio for the triboelectric devices of FIG. 7A, in accordance with one or more embodiments;

FIG. 7C is a graph showing open-circuit voltage for the triboelectric devices of FIG. 7A, in accordance with one or more embodiments;

FIG. 7D is a graph showing open-circuit voltage as a function of effective Poisson's ratio for the triboelectric devices of FIG. 7A, in accordance with one or more embodiments;

FIG. 7E is a graph showing the relationship between v_{eff} and the geometric parameters (φ and t_{lig}) of one (Q2) of the triboelectric devices of FIG. 7A, in accordance with one or more embodiments;

FIG. 7F is a graph showing effective Poisson's ratio for three variants of the triboelectric device of FIG. 7E, in accordance with one or more embodiments;

FIG. 8A is a graph showing electrical structural figure-of-merit as a function of Poisson's ratio for different triboelectric device constructions, in accordance with one or more embodiments;

FIG. 8B is a graph showing open-circuit voltage as a function of different triboelectric device constructions, showing a comparison of VOC and failure modes of the constructions Q2, Q0, ST, and SCT between the theoretical and numerical results, in accordance with one or more embodiments;

FIG. 8C is a graph showing the effect of effective Poisson's ratio and maximum recoverable compressive strain on the FOMₑₛ for triboelectric devices of the Q2 construction and the baselines (Q0 group, ST, and SCT) with the same volume, in accordance with one or more embodiments;

FIG. 8D includes graphs showing effects of geometric parameters (l₀, x₀, and ψ₀) and the loading directions on the FOMₑₛ of Q2 group and T1 group when ε_{yy}=−0.21, in accordance with one or more embodiments;

FIG. 9 includes three different triboelectric device constructions (Q2, T1, and H3), associated displacement vectors (Δx₁, Δx₂, and Δψ), equivalent displacement Δx, and open-circuit voltages V_{OC} versus v_{eff} at a compressive strain of ε_{yy}=−0.21, with star symbols showing the initial values of the above-mentioned parameters (x₁₀, x₂₀, ψ₀, x₀, and V_{OC0}) before compression, while dashed lines show the zero values of the above parameters, in accordance with one or more embodiments:

FIG. 10A is a side elevation view of an example vehicle incorporating triboelectric devices as suspension mechanisms, in accordance with one or more embodiments;

FIG. 10B is an electrical circuit of the vehicle of FIG. 10A, in accordance with one or more embodiments;

FIG. 10C includes graphs showing open-circuit voltage output of the front and rear groups of triboelectric devices during skating forward, turning left, and turning right experiments, with the characteristic curves shown for different skateboard's motions, in accordance with one or more embodiments;

FIG. 10D is a graph comparing z-acceleration for a conventional skateboard without triboelectric devices and the intelligent skateboard of FIG. 10A, in accordance with one or more embodiments;

FIG. 10E includes an electrical circuit showing energy harvesting capacity of the intelligent skateboard of FIG. 10A, and open-circuit voltage as a function of loading time for the intelligent skateboard of FIG. 10A, in accordance with one or more embodiments;

FIG. 10F includes graphs showing open-circuit voltage and reaction force output of triboelectric devices of the Q2 constructions during eight hours (i.e., 2400 cycles) continuously cyclic loading tests, in accordance with one or more embodiments; and

FIG. 11 is a schematic view of an example of a computing device of a controller of an example triboelectric device, in accordance with one or more embodiments.

### DETAILED DESCRIPTION

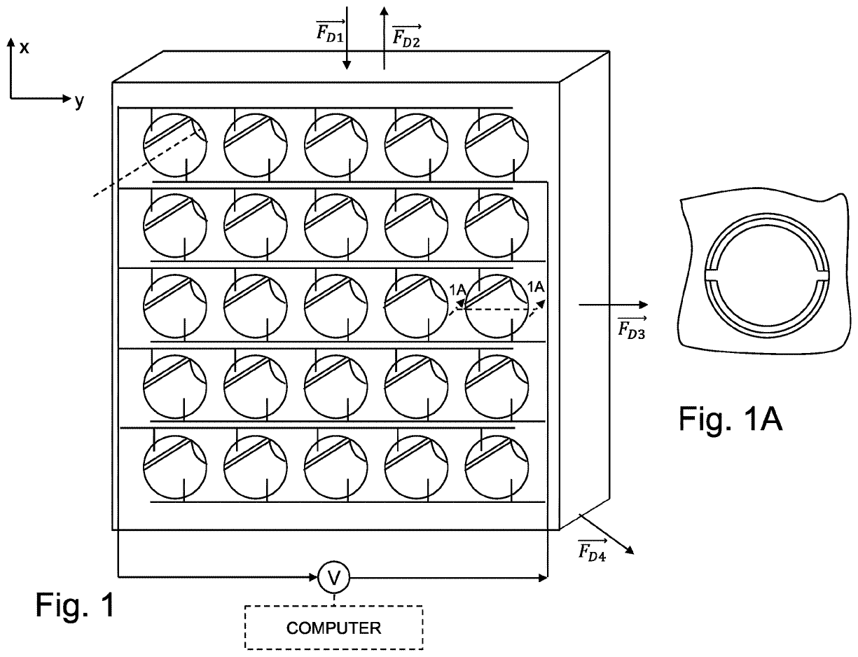

FIG. 1 shows an example of a triboelectric device 10, in accordance with an embodiment of the present disclosure. As depicted, the triboelectric device 10 has a resilient structure 12 and a triboelectric circuit 14. More specifically, the resilient structure 12 has a deformation plane 16, schematically illustrated by the x, y plane in this example, and one or more hollow cells 18 made integral to the resilient structure 12. The number of hollow cells 18, which are adjacent to one another, can vary from one embodiment to another. Each hollow cell 18 has an internal wall 20 with a cross-sectional shape extending along a respective cell axis A. As depicted, the cell axes A of the hollow cells 18 are generally perpendicular to the deformation plane 16. The internal wall 20 of a given hollow cell 18 defines a cavity 22 inside the hollow cell 18, and the internal wall 20 has first and second curved surfaces 24a and 24b distributed around the cavity 22 and facing the cavity 22. As illustrated, the triboelectric circuit 14 has a first electrode assembly 26a covering the first curved surfaces 24a of the hollow cells 18, a second electrode assembly 26b covering the second curved surfaces 24b of the hollow cells 18. The first and second electrode assemblies 26a and 26b are electrically insulated from one another to avoid short-circuit between the first and second electrode assemblies 26a and 26b. Upon deformation of the resilient structure 12 along the deformation plane 16, with deformation forces \vec{F_{D1}}, \vec{F_{DZ}}, \vec{F_{D3}}, or \vec{F_{D4}} for instance, the first and second electrode assemblies 26a and 26b perform a movement relative to one another thereby creating a flow of electric charges across the triboelectric circuit 14. The flow of electrical charges can form an electrical current or voltage which can be used by one or more electrical device(s), example of which are described below.

As best shown in FIG. 1A, the first and second electrode assemblies 26a and 26b each have an electrically conductive layer 28 and an electrically insulating layer 30 covering the electrically conductive layer 28 in some embodiments. The electrically conductive layers 28 of both the first and second electrode assemblies 26a and 26b are generally provided in the form of a sheet of electrically conductive material. The type of metal can depend on the embodiment. For instance, the electrically conductive material can be a metal such as copper, silver, gold, zinc and the like, graphene and any other electrically conductive material. As illustrated, the electrically insulating layer 30 of the first electrode assembly 26a faces the electrically insulating layer 30 of the second electrode assembly 26b across the corresponding cavity 22. In some embodiments, the first and second electrode assemblies 26a and 26b are laminated onto or snugly fitted against a respective one of the first and second curved surfaces 24a and 24b. In some embodiments, the electrically insulating layer 30 of the first electrode assembly 24a is made of a first electrically insulating material, and the electrically insulating layer 30 of the second electrode assembly 24b is made of a second electrically insulating material different from the first electrically insulating material. For instance, the first electrically insulating material can be polyethylene terephthalate (PET) and the second electrically insulating material can be polytetrafluoroethylene (PTFE) in some embodiments, or vice versa. Different combinations of electrically insulating materials can be used, depending on the embodiment. Other electrically insulating material examples can include, but are not limited to, fluorinated ethylene propylene (FEP), nylon, polyurethane (PU), polyimide such as Kapton, polyethylene terephthalate (PETG), and the like.

Referring to FIGS. 1 and 1A concurrently, the electrically conductive layers 28 of the first electrode assembly 26a are electrically connected to one another via a first conductor 32a. Similarly, the electrically conductive layers 28 of the second electrode assembly 26b are electrically connected to one another via a second conductor 32b. In these embodiments, the flow of electric charges generated at the triboelectric circuit 14 can be supplied to one or more electrical device(s) via the first and second conductors 32a and 32b. Examples of such an electrical device can include, but are not limited to, capacitor(s), light(s), controller(s) and the like. In some other embodiments, each of the electrically conductive layers 28 of the first and second electrode assemblies 26a and 26b are electrically connected to the electrical device(s) via respective conductors (not shown). In some embodiments, the flow of charges generated at the triboelectric circuit 14 can be used to provide an electrical current i above an electrical current threshold iₜₕ to the electrical device(s) (i.e., i>iₜₕ) to perform electrical functions. In other embodiments, such as described in greater detail below, a controller 36 can be used to determine an amplitude and/or a direction of the deformation imparted onto the triboelectric device depending on the monitored flow of electrical charges generated by the first and second electrode assemblies 26a and 26b.

The resilient structure 12 itself is made of a resilient material including, but not limited to, rubber, polypropylene (PP). The resilient structure 12 can have any size, shape or form, depending on the embodiment. For instance, examples of the cross-sectional shapes of the hollow cells can include, but are not limited to, a triangular-like shape, a circular-like shape, an ovoid-like shape, a quadrilateral-like shape, a hexagonal-like shape, a horseshoe-like shape, or a combination thereof. Indeed, although the illustrated hollow cells are all of circular shapes, some hollow cells of the resilient structure can have different cross-sectional shape(s). In some embodiments, the hollow cells 18 are arranged in a tessellation of hollow cells 18 having resilient walls which are made integral to one another, thereby forming the resilient structure 12. The resilient structure can be monolithic or be formed of a number of different resilient or not so resilient pieces arranged together, depending on the embodiment.

In some embodiments, the resilient structure 12 is auxetic. In other words, its construction is such that a deformation causes the resilient structure 12 to become thicker perpendicular to an exerted deformation force when stretched and/or to become thinner perpendicular to the exerted deformation force when compressed. In some embodiments, some of which are described below, the relative movement between the first and second electrode assemblies 26a and 26b includes a rotational movement, a translational movement, a torsional movement, or any combination thereof. In the present disclosure, different constructions of the resilient structure 12 are disclosed, some of which including rotational movements of the first and second electrode assemblies 26a and 26b relative to one another (referred to as angle-changing types), some other of which including translational movements of the first and second electrode assemblies 26a and 26b relative to one another (referred to as distance-changing types), and others are mixed-types including both rotational and translational movements.

In some embodiments, the first and second curved surfaces 24a and 24b differ in circumferential positioning from one hollow cell 18 to another. In those embodiments, the orientation of the first and second electrode assemblies 26a and 26b in each of the hollow cells 18 can differ, thereby allowing electrical charges to be created when the resilient structure is deformed into more than one orientation parallel of the deformation plane 16. For instance, some of the hollow cells 18 are arranged in a first electrode positioning arrangement P_{A} whereas some other of the hollow cells 18 are arranged in a second electrode positioning arrangement P_{B} different from the first electrode positioning arrangement P_{A}. Although only two different electrode position arrangements are shown in the embodiment of FIG. 1, it is understood that in some other embodiments more than two different electrode position arrangements can be used as well. It is intended that when the resilient structure 12 has an auxetic construction, then the deformation of the resilient structure can trigger movement of more than one of the electrode positioning arrangements. Accordingly, there is a synergy existing between the differing orientations of the first and second electrode assemblies in each of the hollow cells 18 and the auxetic construction of the resilient structure 12.

In some embodiments, the hollow cells 18 are open on both sides. More specifically, the resilient structure 12 has a first lateral side 38a exposing first openings 40a of the hollow cells 18, and a second lateral side 38b exposing second openings 40b of the hollow cells 18, in which the second openings 40b are opposite to the first openings 40a. In these embodiments, the first electrode assembly 26a can have first flaps 42a inserted into the hollow cells 18 via the first openings 40a in order to cover the respective first curved portions 24a of the internal walls 20 of the hollow cells 18. Similarly, the second electrode assembly 26b can have second flaps 42b inserted into the hollow cells 18 via the second openings 40b in order to cover the respective second curved portions 24b of the internal walls 20 of the hollow cells 18. In this example, the first conductor 32a interconnects the first flaps 42a to one another, and can extend or otherwise be accessed on the first lateral side 38a of the resilient structure 12. The second conductor 32b interconnects the second flaps 42b to one another, and can extend or otherwise be accessed on the second lateral side 38b of the resilient structure 12. In these embodiments, electrically insulating flaps can be positioned atop the respective first and second flaps 42a and 42b to form the first and second electrode assemblies.

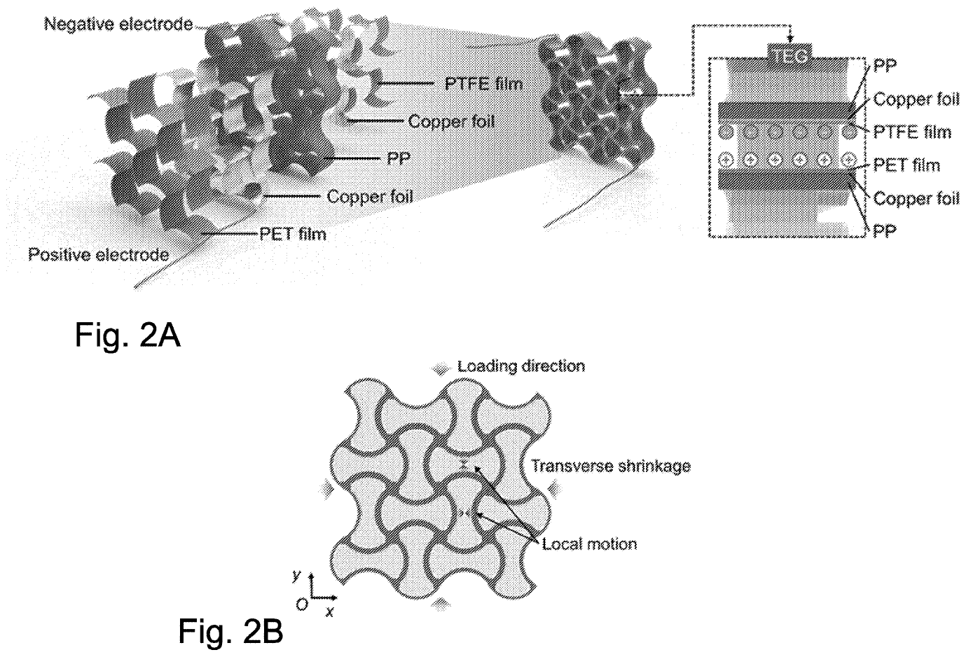

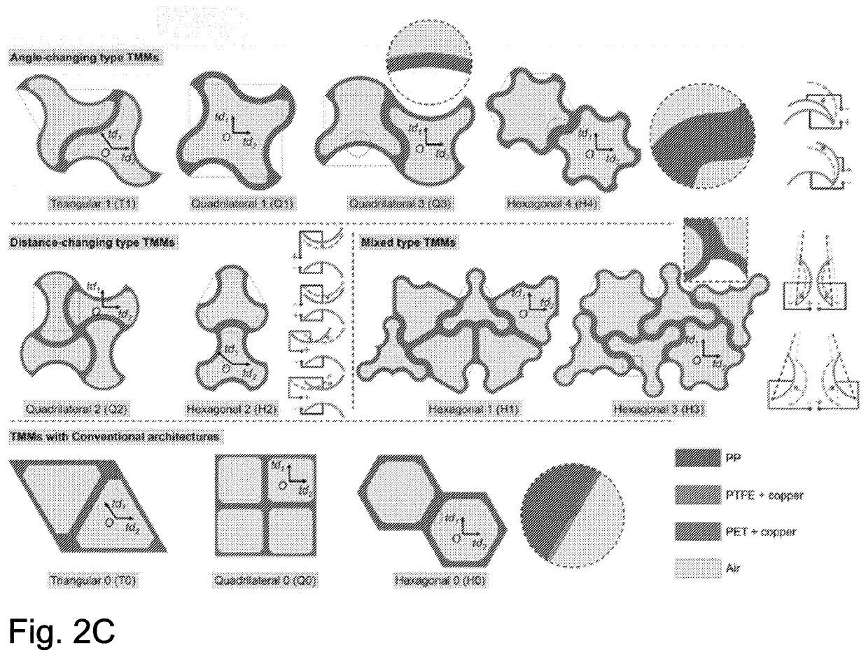

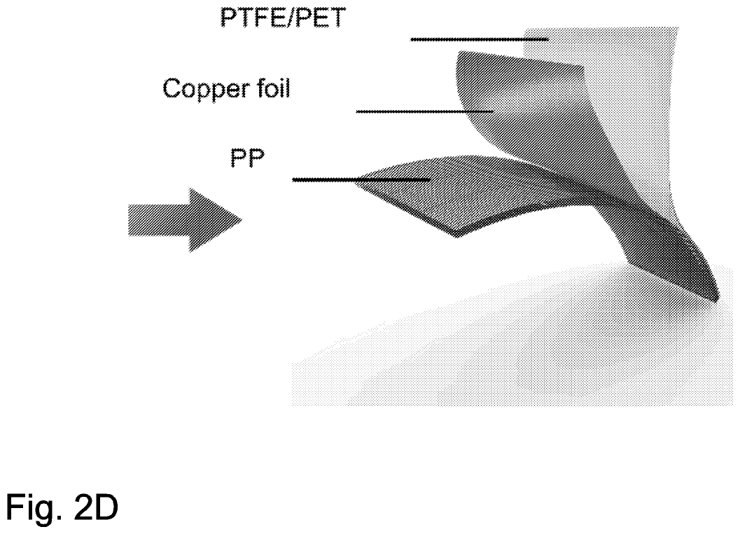

FIG. 2A shows another example of a triboelectric device 110. As depicted, triboelectric device 110 has a resilient structure 112 having a deformation plane 116, and hollow cells 118 having internal walls 120 having a cross-sectional shape extending along a respective cell axis A perpendicular to the deformation plane 116. The internal walls 120 define a cavity 122 thereinside, and having first and second curved surfaces 124a and 124b distributed around the cavity 122 and facing the cavity 122. The triboelectric device 110 has a triboelectric circuit 114 having a first electrode assembly 126a covering the first curved surfaces 124a, a second electrode assembly 126b covering the second curved surfaces 124b. The first and second electrode assemblies 126a and 126b are electrically insulated from one another. As shown, each of the first and second electrode assemblies 126a and 126b has a respective electrically conductive layer 128 and an electrically insulating layer 130 covering the electrically conductive layer 128. During use, the resilient structure 112 deforms along the deformation plane 116, which in turn causes the first and second electrode assemblies 126a and 126b to perform a movement relative to one another thereby creating a flow of electric charges across the triboelectric circuit 114. In some embodiments, such as the one illustrated, the electrically conductive layer 128 and the electrically insulating layers 130 of the first and second electrode assemblies 126a and 126b are provided in the form of flaps which can be inserted into the cavities 122 of the resilient structure 112 via respective lateral sides thereof.

The following paragraphs describe different embodiments of the present disclosure, and are meant to be exemplary only.

### Example—Curved Architected Triboelectric Metamaterials: Auxeticity-Enabled Enhanced Figure-of-Merit

Triboelectric devices, also referred to triboelectric generators (TEGs) in this example, are integrated into curved architected materials to realize triboelectric metamaterials that simultaneously harvest electricity from wasted mechanical energy and perform energy absorption capability. Novel triboelectric mechanical metamaterials (TMMs) of distance-changing, angle-changing, and mixed modes are designed, fabricated, and tested under a cyclic compressive load. The open-circuit voltage and short-circuit current of lightweight TMMs are found to be as high as 40 V and 10 nA. The introduced TMMs can effectively harvest energy under loadings from two distinct directions. A theoretical model for predicting the energy harvesting properties of TMMs is developed, and the role of auxeticity on the energy harvesting figure-of-merit (FOMes) is elicited. The introduced TMMs exhibit enhanced FOMes enabled by a decrease in their negative Poisson's ratio and an increase in their resilience. The FOMes of curved architected TMMs surpasses by more than sixteen times the FOMes of triboelectric materials with conventional architectures (i.e., triangular, quadrilateral, and hexagonal cell topologies). An intelligent skateboard with integrated TMMs is fabricated as a proof-of-concept to demonstrate motion sensing, shock-absorbing, and energy harvesting functionalities of triboelectric metamaterials. The introduced design strategy for triboelectric metamaterials unlocks their applications in self-powered and self-monitoring sports equipment, smart soft robots, and large-scale energy harvesters.

With the rapid growth of the Internet of Things (IoTs) and portable devices, more attention has been given to the development of mobile power sources and self-powered sensors. Ambient mechanical energy (AME) (e.g., hydrokinetic, sound, and biomechanical energy), a clean and widely available form of energy, has been one of the most sought-after wasted resources to be harvested. The triboelectric effect, also known as triboelectric charging, is a type of contact electrification on certain insulators after they are separated from a material they were contacted or rubbed (henceforth the tribo prefix, a Greek word means ‘rub,’ is referring to ‘friction’ in triboelectricity). To convert AME into electricity with low cost and high efficiency, triboelectric effect and electrostatic induction, two common phenomena in daily life, were firstly combined as generators, also named triboelectric generators (TEGs). Even though there are many variants of TEGs, a TEG generally consists of insulators, which are called triboelectric layers, as the source of triboelectric charging and conductors as electrodes. The insulators are electrified after separation from another component (insulator or conductor) with a work function difference. The electrical charges at the far end of an electrode from the insulator, driven by the electrostatic induction and electromotive force, are transferred to another electrode and form an electric current when both are connected in a closed circuit.

By virtue of advanced micro/nano-additive manufacturing, multifunctional metamaterials (M²s) constructed with rationally designed micro/nano-structures open new avenues for attaining programmable, intractable, and counter-intuitive multiphysical properties (e.g., negative Poisson's ratio, tunable electromagnetic permittivity, structural multistability, and electrochemical reconfigurability) that are inaccessible in naturally occurring or conventional synthetic materials. Among the diverse classes of M²s, curved architected mechanical metamaterials inspired by the wavy network microstructures found in soft biological tissues (such as an actin filament or a collagen fibril), typically feature impressive resilience. The microstructures of this class of emerging mechanical metamaterial are also named horseshoe architectures. Additionally, Poisson's ratio of horseshoe architected materials can be precisely customized in a wide range, which facilitates their potential applications in programmable flexible electronics. Considering the coexisting demands of load-bearing, mechanical energy absorbing, energy converting, and autonomous sensing/actuating properties in IoTs, it is of great interest to develop the next generation of electromechanical metamaterials by integrating TEGs into M²s, and thereby realize triboelectric multifunctional metamaterials (TMMs). In the past few years, TMMs have been designed out of beam array, snapping, honeycomb, chiral or hierarchical architectures as substrates, together with embedded, inserted, or attached TEGs to demonstrate their energy harvesting, sensing, vibration suppressing, and load impact reducing capabilities. Despite the recent efforts to create new architected triboelectric materials, it is yet to be uncovered if auxeticity can be capitalized to enhance the electrical performance of architected triboelectric metamaterials while providing remarkable mechanical properties. There is also a lack of analytical tools to quantify the efficiency of triboelectric metamaterials for the optimization of their electrical output, exclusively when multiple working modes of TEGs co-exist due to the complex intrinsic deformation mechanisms of their underlying architecture. First, TMMs are required to be highly resilient and remarkable in energy absorption for a long lifespan under cyclic loadings. Second, the electrical networking TEGs should be synchronized in yielding electric voltages or currents for the maximization of electric output. Finally, TMMs should be able to harvest energy and sense external excitations from arbitrary directions.

This example experiment introduces, for the first time, design, fabrication, and optimization strategies for the realization of auxetic TMMs with tailorable mechanical properties (i.e., stiffness, specific energy absorption, and maximum recoverable compressive strain) and efficient energy harvesting characteristics. The electromechanical properties including deformation modes, voltage, and current output of this new class of TMMs are examined through experiments and compared to the conventionally architected counterparts, namely regular triangular, quadrilateral, and hexagonal architectures. Theoretical models for electrical output and finite element (FE) models are developed to quantitatively investigate the influence of topological parameters of underlying architectures of TMMs on their energy harvesting figure-of-merit. The roles of auxeticity (i.e., negative Poisson's ratio, which leads to transverse contraction when the metamaterial is compressed longitudinally) in promoting uniform deformation and synchronizing all TEGs connected in parallel are explored. This example experiment sheds light on the engineering application schemes of TMMs as building blocks of intelligent load-bearing infrastructures, including micro/nano power sources, self-powered sensors, and wearable electronic devices.

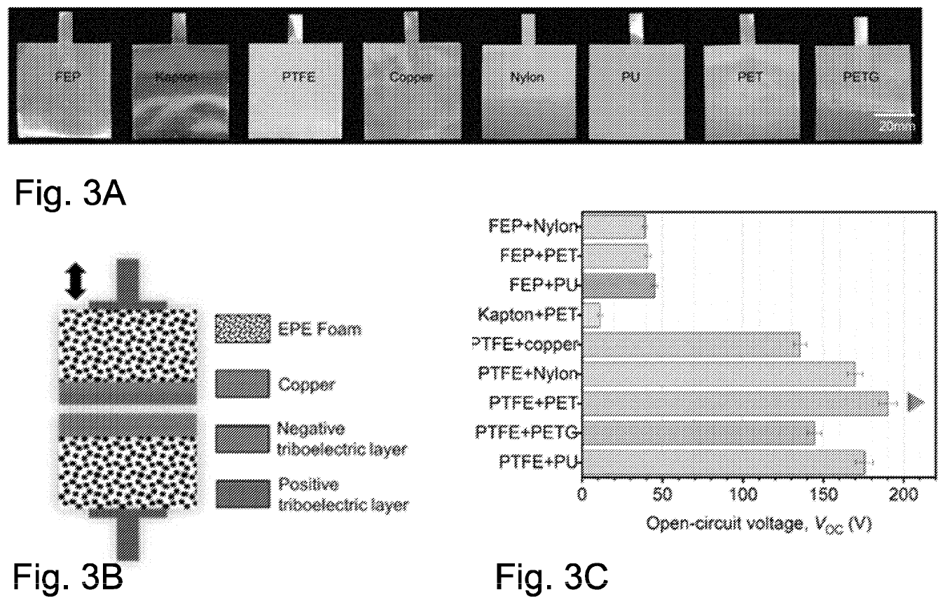

In this example, the unit cells of TMMs are designed by capitalizing curved walls in triangular, quadrilateral, and hexagonal cellular architectures. The in-plane bending of the horseshoe-shaped cell walls is expected to drive the opposite triboelectric surfaces to approach each other in a TMM under compression, and to facilitate the generation of electricity. Triangular, quadrilateral, and hexagonal cellular materials are selected as basic underlying architectures since they are the only solutions for the realization of regular tiling in a Euclidean plane. As identified in a previous eigenmode analysis on these polygonal cells, eight cellular architected designs with curved walls can be identified to demonstrate auxetic behaviours. A TEG contained in the TMMs is separated into two parts (named tribo-pairs, i.e., negative-charge-attractive layer/electrode and positive-charge-attractive layer/electrode) attached to adjacent cell walls that contact each other under compression, as shown in FIG. 2A. Polyester (PET) and Polytetrafluoroethylene (PTFE) are selected from a wide range of potential insulator candidates as the positive- and negative-charge-attractive materials to form the integrated TEGs mainly due to their highest open-circuit voltage generation when it is operated in a contact-separation mode. Copper is used as the electrode materials. Polypropylene (PP) is selected as the parent material for the insulating cellular substrate of the TMMs since its flexibility provides TMMs with mechanical resilience and damage tolerance, extending their life span. FIG. 2B briefly explains the role of auxeticity in driving the TEGs distributed in x direction when the TMM is under compression in y direction. To increase the chance of internal contact of every TEGs under cyclic compressive loadings, finite element method (FEM) simulations of the corresponding cellular substrate with the above-mentioned architectures have been first conducted under a multi-axial compression in order to optimize the positions of tribo-pairs in TMMs, as presented in FIG. 3.

To construct TMMs with a remarkable voltage output, the best combination of opposite triboelectric layers is selected from a wide range of candidates by conducting cyclic-loading experiments on contact-separation TEGs containing a pair of the selected candidates. As reported in the literature, fluorinated ethylene propylene (FEP), Kapton, and PTFE show the greatest capability to obtain electrons with negative charges and thereby are listed as candidates for negative triboelectric layers. Meanwhile, Nylon, polyurethane (PU), PET, copper and Polyethylene Terephthalate (PETT) are prone to electron losses and hence are selected as candidates for positive triboelectric layers. The material selection of the triboelectric layer is conducted according to the following procedures. Firstly, the negative and positive layers (in the form of acrylic adhesive-back films) are attached to two copper electrodes with the same areas, as shown in FIG. 3A. Then, the triboelectric layer-copper composites are attached to two Expanded Polyethylene (EPE) foam grips to realize full contact with the opposite triboelectric layers under compression, as shown in FIG. 3B. Finally, a cyclic loading is applied at a rate of 3 mm/s. All the opposite triboelectric layers underwent a compressive displacement of 4 mm before the contact and followed by a 0.55 mm compressive displacement after the initial contact to enhance the triboelectrification. The maximum open-circuit voltages of nine different combinations of negative and positive layers are compared in FIG. 3C where the combination PTFE+PET shows the highest-voltage output. Therefore, PTFE and PET are selected as the materials for the triboelectric layers in the current research.

The densities of PP, PTFE-copper film, and PET-copper film are calculated by dividing the weight by the volume. The mechanical properties (Young's modulus and ultimate strength) of PP, PTFE-copper film, and PET-copper film are measured by conducting tensile test experimentations. Referring to the standard ASTM D638-14, dog-bone shape samples of PP are fabricated by 3D printing using an Ultimaker fused deposition modelling (FDM) 3D printer with a total length of 162 mm, a cross-section of 13 mm×3 mm and a narrow section of 70 mm in length, as shown in FIG. 3D. The tensile tests are conducted by an ADMET eXpert 8612 universal mechanical testing machine with a 4500 lbf (20.02 kN)-capacity load cell. An extensometer with a gauge length 50 mm is used to accurately measure the tensile strain. Tensile tests with a loading rate of 50 mm/min are implemented. At least three samples are tested for each loading rate to ensure the repeatability of results. Stress-strain curves of all the tests are presented in FIG. 3D. The Young's modulus E is calculated as the slope of the linear stage of the stress-strain curve, while the ultimate strength σᵤ is defined as the maximum stress value in the curve. Rectangular samples of PTFE-copper film and PET-copper film are prepared by attaching a ribbon of PTFE or PET AABF to a copper AABF with the same area. The dimensions of the PTFE-copper film and PET-copper film samples are 150 mm×10 mm×0.3 mm according to ASTM-D882-18 standard, as shown in FIG. 3D. Tensile tests with a loading rate of 50 mm/min are implemented on the composite samples. At least three samples are tested for each composite type to ensure repeatability. The Young's modulus and the ultimate strength are obtained with the above-mentioned methods.

The relative permittivities εᵣ (dielectric constants) of PP, PTFE AABF, and PET AABF are measured in accordance with ASTM D150 standard; the dimensions of square shape PP, PTFE AABF, and PET AABF samples for the measurement are 10 mm×10 mm×0.27 mm, 10 mm×10 mm×0.44 mm, and 10 mm×10 mm×0.12 mm, respectively. The PP samples are 3D printed by FDM. PP, PTFE AABF, and PET AABF samples are attached between two 10 mm×10 mm×1 mm electrode plates separately. The capacitances between two electrode plates are measured by an SR715 L-C-R meter.

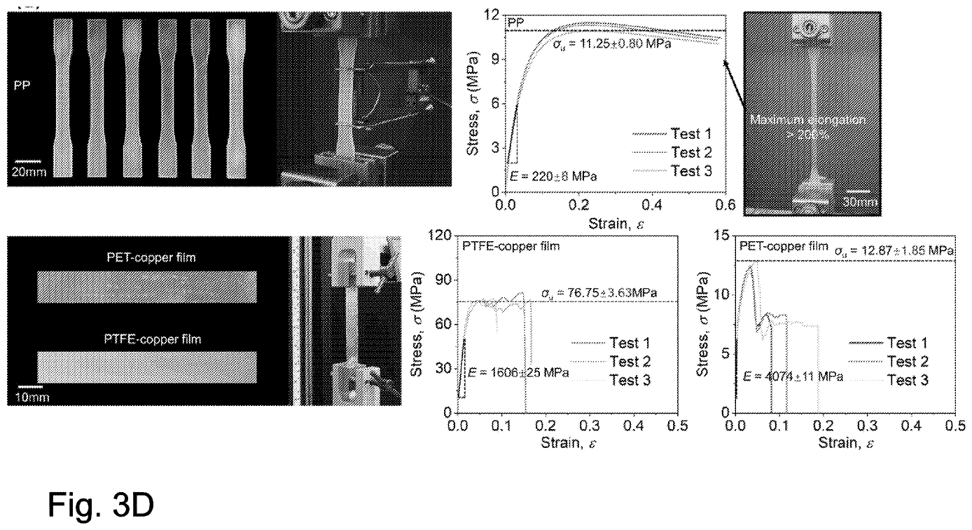

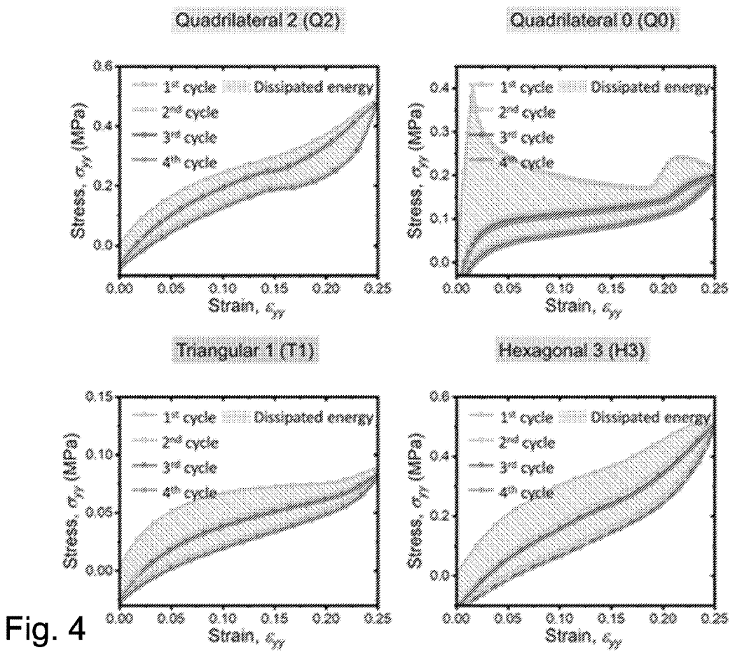

According to the different working principles shown in FIG. 2C of the integrated TEGs, eight TMM designs with curved cell walls are divided into three types, i.e., angle-changing, distance-changing, and mixed-type TMMs. A TEG in angle-changing TMMs features two triboelectric surfaces sharing the same axis of rotation, while a TEG in distance-changing TMMs is composed of two triboelectric surfaces taking relative translational motion but without relative rotation. A TEG in the mixed-type TMMs takes both kinds of motions for its working principle. Meanwhile, TMM designs with triangular, quadrilateral, and hexagonal architectures are selected to examine the electromechanical performance of the developed TMMs with underlying horseshoe architectures. All the TMM designs are named by the abbreviation of the substrate geometries and a specific number, as presented in FIG. 2C. To simplify the modelling procedure without losing the generality, each curved cell wall is modelled as an arc with a central angle of €>=120°. Chamfers are introduced to avoid short-circuit of two adjacent electrodes and local stress concentration leading to damage of the cellular substrates. The working principles (also named working modes) are illustrated by the displacement of the tribo-pairs and the generated electric potential changes at electrodes, as shown on the right-most part of FIG. 2C. The design bases, including triangular, quadrilateral, and hexagonal cells, are presented with grey dash lines. The vectors for two-dimensional tessellation directions (td1 and td2) for these unit cells to form metamaterials are shown. For comparison of structural efficiency of electrical output, all the TMMs possess the same triboelectric surface area for a single TEG. More information on the geometrical parameters of the unit cell design can be found in FIG. 4.

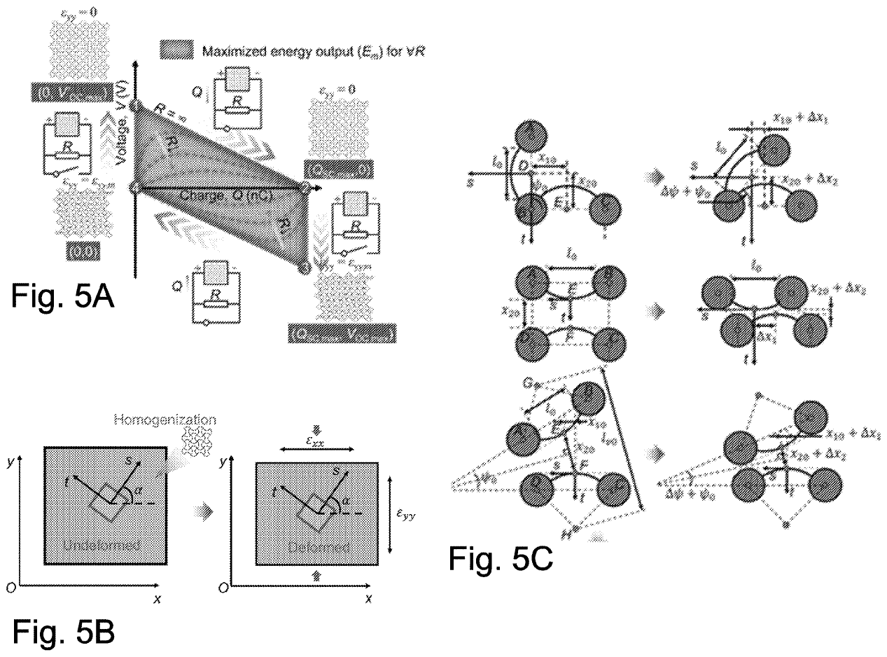

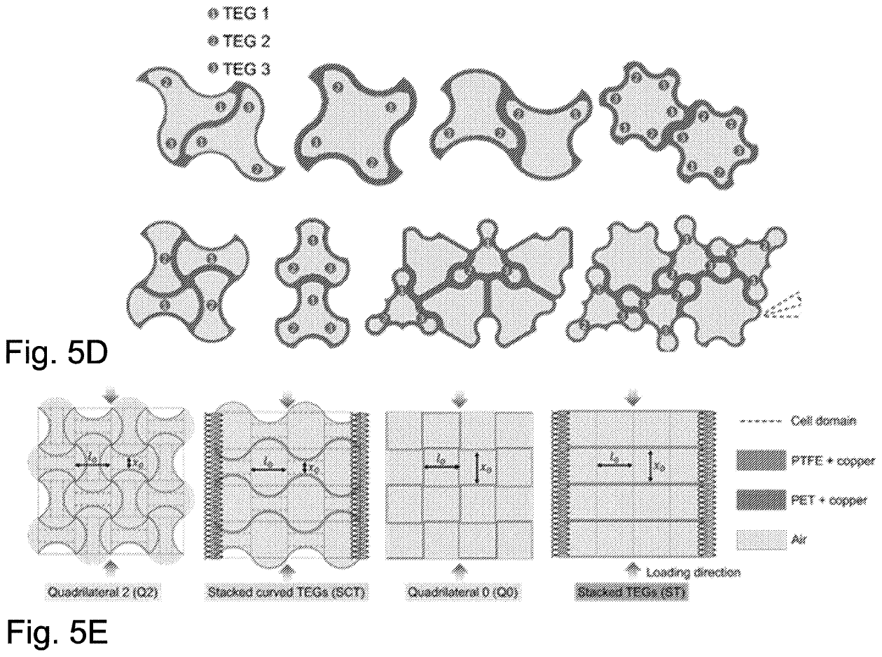

The relative densities pr of all TMM designs can be theoretically determined as presented in FIG. 4 and are controlled to be identical (i.e., ρᵣ=0.3) by adjusting the thickness of the cell walls to. To evaluate if the electrical structural efficiency of the designed TMMs can surpass the conventional plate-like TEG structures and multi-layered TEG structures based on plate-like TEG structures, stacked TEGs (ST) model is designed as a representative of the plate-like and multi-layered TEG structures as shown in FIG. 5E. Moreover, stacked curved TEGs (SCT) are proposed in FIG. 5E as a conceptual combination of stacked TEGs and curved struts. TEGs in the ST and SCT designs are distributed to work only in y direction. Therefore, ST and SCT are not as capable as TMMs proposed in the current example in harvesting energy and bearing loads applied in multiple directions. Both ST and SCT possess the same layer height l₀ and relative density ρᵣ as the Q2 design, but the adjacent layers are connected by spring-like structures to realize resilience in the structure.

The TMM samples are fabricated using the electrode assemblies shown in FIG. 2D. Firstly, the substrates of TEGs, namely the cellular material parts of TMMs, are fabricated through fused deposition modelling (FDM) 3D printing out of PP polymers as the parent material. Then, the copper electrodes in the form of acrylic adhesive-back films (i.e., copper AABFs) with a dimension of 12.7×10×0.05 mm are attached to the designated positions of the cellular substrate. All electrodes in a TMM are connected in parallel with copper AABFs ribbons of 2 mm width. Finally, PTFE and PET AABFs from McMaster-Carr® with a dimension of 12.7×10×0.25 mm are attached to the electrodes. All the above-mentioned AABFs are shaped by a Trotec Speedy 100® laser cutter.

To investigate the mechanical and electrical behaviours of TMMs under cyclic loading, electromechanical experimentations are carried out on four alternative TMM samples made out of T1, Q2, H3, and Q0 architectures as representatives for the angle-changing, distance-changing, mixed-type, and conventional TMMs with 2×2 unit cells. These samples are adhesively connected to upper and lower fixtures. All cyclic loading tests are conducted on a universal mechanical test machine ADMET eXpert 7601 with a 250 lbf (1.11 kN)-capacity load cell. A compressive strain sequence of

$${\overbrace{[ - 0.25 , 0 , - 0.25 , … , 0 , - 0.25 , 0 ]}}^{30 cycles}$$

is applied by moving the upper end of samples at a loading rate of 2 mm/s, while the lower end is clamped fixed to the test machine. The compressive strain of −0.25 is determined to guarantee that all the TMMs samples can undergo the first inner contact before the end of compression. Open-circuit voltage output (V_{OC}) and short-circuit current output (I_{SC}) are measured using a Keithley 6517a electrometer. Short-circuit transferred charge amount (Q_{SC}) is calculated by

$${Q}_{SC} = {\int }_{0}^{{t}_{c}} I ( t ) dt ,$$

where t_{c} is the ending time of a loading cycle. A LabVIEW-based program has been developed to control electrometer measurements and to store readings in the host computer. At least three replicates are tested for each TMM architecture to ensure the repeatability of experimental results. In the first several loading cycles, the charge density on the triboelectric surface gradually reaches a maximum value by contact electrification. In the following cycles, the TMMs present repeated oscillation of reaction force-time, open-circuit voltage-time, and short-circuit current-time outputs until the tests are completed, confirming their potential for serving as a cyclic load-bearable engineering materials for a prolonged lifespan.

To develop a quantitative predictive model for exploring the multiphysical behaviours of alternative TMMs, electromechanical FEM simulation is utilized. COMSOL Multiphysics Version 6.0 is used as the FEM platform, in which the Structural Mechanics and AC/DC modules are combined to solve the electromechanical problem involving nonlinear geometric deformation, electric potential variation of deformed domains, and charge transfer in a circuit. Semi-detailed CAD models of the TMM designs with 4×4 unit cells are imported into COMSOL Multiphysics software for two-dimensional analysis with plane-strain approximations, in which the exact planar geometry of the PP cellular substrate is modelled, while the PTFE/PET layers and the adjacent electrodes are composited into an equivalent area, neglecting the effect of the 0.05 mm thin copper AABFs on the overall mechanical properties. Specifically, these equivalent areas are endued with mechanical properties of the corresponding composite layers from experiments. The surface charges, zero potential and floating potential, are defined on the triboelectric layers, electrode layers beneath PET layers, and electrode layers beneath PTFE layers, respectively. All the above layers are perfectly bonded with sharing element nodes. Elastoplastic material properties of PP, PTFE-electrode composite layer, and PET-electrode composite layer are used. The bulk densities of the materials are measured through direct measurement of mass and apparent volume. The mechanical properties (i.e., Young's modulus E and initial yield stress σ_{y}) of PP and the two composite films (PTFE-copper and PET-copper) are obtained from the tensile tests. Plasticity in all solids is considered with a perfectly plastic isotropic hardening model. The Poisson's ratios of the three materials (i.e., PP, PET-copper, and PET-copper) are assumed to be 0.38, while their relative permittivities are measured.

After a mesh sensitivity analysis, each narrow area member (i.e., PTFE-electrode layer, PET-electrode layer, or PP strut area) is modelled by at least two shell elements in the thickness direction of TMMs. The moving mesh method is applied to the air domain to simulate the topological changes of underlying architectures induced by the deformation of solid materials while avoiding premature element distortion at the interface between gas and solids. The charge density on the surface of triboelectric layers, which is difficult to predict due to the complexity of contact electrification mechanisms, is the subject of manipulation as it linearly scales the simulated electric output. The simulated maximum open-circuit voltage can be close to the experimental values when the charge density σ is specified as 2.52×10⁻⁶ C/m².

The structural transient behaviour of quasistatic is set, which means there are no second-order time derivatives in the formula. Backward differentiation formula is used to solve this time-dependent nonlinear electrostatic-structural mechanics problem, which is an implicit method. The numerical study of electric output is conducted via a pre-set charge equilibrium strategy simulating the steady electric output of TMMs after several loading cycles. To examine the auxetic behaviour of the TMMs, the effective Poisson's ratio v_{eff} is also measured by Overvelde's method. The motions of the nine vertices of four central RVEs (Representative Volume Elements) are monitored, as their motion response is clearly more uniform and less affected by the boundary conditions than the other RVEs. The resilience of TMMs is quantitatively evaluated by the maximum recoverable compressive strain (ε_{yy,m}), which is defined as the compressive strain when the ratio of dissipated energy, due to the plasticity of base polymers, reaches 10% of the total input mechanical energy. Specific energy absorption (SEA) and maximum open-circuit voltage V_{oc,max} of TMMs are also defined by the following equations:

$$A = \frac{1}{ρ} {\int }_{0}^{{ε}_{yy , max}} {σ}_{yy} d {ε}_{yy} ; and \qquad ( 1 )$$

$${V}_{OC , max} = max [ {V}_{OC} ] {\vert}_{{ε}_{yy} = 0 ∼ {ε}_{yy , max}} . \qquad ( 2 )$$

A theoretical model is established for the electric energy output of TMMs in a cycle for maximum energy output (CMEO) based on a previously reported model for contact-mode triboelectric materials. The CMEO of the TMMs is obtained by alternating close-circuit/open-circuit conditions and alternating uniaxial strains applied to the TMMs, as shown in FIG. 5A. The theoretical upper bound of energy output Eₘ can be calculated according to the following Equation 3a when the resistance of external loading is approaching infinity; TEG working modes observed in experiments and simulations, including angle-changing, distance-changing, and mixed mode contact-separation are considered in this theoretical model:

$${E}_{m} = \frac{1}{2} {Q}_{SC , max} ( {V}_{OC , max}^{′} - {V}_{OC , max} ) ; \qquad ( 3 a )$$

$${Q}_{SC} = {N V}_{OC , max}^{′} {C}_{Total} ; \qquad ( 3 b )$$

$${V}_{OC} = ( σ {l}_{0} w - {V}_{ref , max} {C}_{Total , max} ( \frac{1}{{C}_{x}} - \frac{1}{{C}_{x , min}} ) ) ; \qquad ( 3 c )$$

$${V}_{OC}^{′} = ( σ {l}_{0} w - {V}_{ref , max} {C}_{Total , max} ( \frac{1}{{C}_{x}} - \frac{1}{{C}_{x , max}} ) ) ; \qquad ( 3 d )$$

$${C}_{Total} = \frac{{C}_{x} {C}_{d 1} {C}_{d 2}}{{C}_{x} ( {C}_{d 1} + {C}_{d 2} ) + {C}_{d 1} {C}_{d 2}} ; \qquad ( 3 e )$$

$${C}_{Total , max} = \frac{{C}_{x , max} {C}_{d 1} {C}_{d 2}}{{C}_{x , max} ( {C}_{d 1} + {C}_{d 2} ) + {C}_{d 1} {C}_{d 2}} ; and \qquad ( 3 f )$$

$${V}_{ref , max} = \frac{σ {l}_{0} w}{{C}_{x , max}} ; \qquad ( 3 g )$$

where N is the number of TEGs inside a TMM; σ is the charge density of the triboelectric surfaces; Q_{SC} is the charge transfer between the two electrodes of each TEG; V_{OC} and

$${V}_{OC}^{′}$$

are the open-circuit voltage at stage three and stage one in a CMEO, respectively; l₀ an w are the length and width of the simplified triboelectric surfaces; Cₓ is the capacitances between two triboelectric surfaces of a TEG that varies with the equivalent distance x between the triboelectric surfaces; C_{d1} and C_{d2} are the capacitances between negative/positive triboelectric surfaces and the attached electrodes, respectively. In the current theory, two curved triboelectric surfaces of a TEG are simplified by two flat planes (two red dash lines in the 2D schematic graph of FIG. 5C), defined as rigid bodies by the following rules: for angle-changing type TEGs, the ends of the two curved triboelectric surfaces [symbol] serve as the ends of the simplified planes (A̅B̅, B̅C̅); for distance-changing and mixed type TEGs, the simplified planes meet the curved triboelectric surfaces at the midpoint (E and F) and are parallel to the planes connecting the ends of the curved triboelectric surfaces [symbol] The validity of the simplified model is examined by comparing the V_{oc} of TEGs with curved triboelectric surfaces and those with the equivalent planes using FEM simulations. Considering the edge effect of a capacitor, the capacitances inside a TEG can be expressed by equations from previous research:

$${C}_{x} = {ε}_{0} {ε}_{r} \frac{{l}_{0} w}{x} ( 1 + \frac{x}{π {l}_{0}} ( 1 + ln ( 1 + 2 π \frac{{l}_{0}}{x} + ln ( 1 + 2 π \frac{{l}_{0}}{x} ) ) ) ) ; \qquad ( 4 a )$$

$${C}_{d 1} = {ε}_{0} {ε}_{r 1} \frac{{l}_{0} w}{{d}_{1}} ( 1 + \frac{{d}_{1}}{π {l}_{0}} ( 1 + ln ( 1 + 2 π \frac{{l}_{0}}{{d}_{1}} + ln ( 1 + 2 π \frac{{l}_{0}}{{d}_{1}} ) ) ) ) ; \qquad ( 4 b )$$

$${C}_{d 2} = {ε}_{0} {ε}_{r 2} \frac{{l}_{0} w}{{d}_{2}} ( 1 + \frac{{d}_{2}}{π {l}_{0}} ( 1 + ln ( 1 + 2 π \frac{{l}_{0}}{{d}_{2}} + ln ( 1 + 2 π \frac{{l}_{0}}{{d}_{2}} ) ) ) ) ; \qquad ( 4 c )$$

where ε₀=8.854×10⁻¹² F/m is the absolute permittivity of vacuum; x for arbitrary working modes can be derived by the following Equation 5. By considering the strain vectors of the concerned area of a TMM in FIG. 5B, the local coordination of the concerned area, and the detailed model of the local motion of a single TEG in FIG. 5C:

$$x = {\underbrace{\sqrt{{( {x}_{2} )}^{2} + {( \frac{{d}_{0} {x}_{1}}{{l}_{0} - \vert {x}_{1} \vert} )}^{2}}}}_{distance - changing} {\underbrace{cos ( \frac{ψ + {ψ}_{0}}{2} )}}_{angle - changing} ; \qquad ( 5 a )$$

$${x}_{1} = {x}_{10} + Δ {x}_{1} ; \qquad ( 5 b )$$

$${x}_{2} = {x}_{20} + Δ {x}_{2} ; and \qquad ( 5 c )$$

$${d}_{0} = \frac{{d}_{1}}{{ε}_{1}} + \frac{{d}_{2}}{{ε}_{2}} ; \qquad ( 5 d )$$

where d₁ and d₂ are the thickness of the two triboelectric layers (herein PTFE and PET layers); ε₁ and ε₂ are the relative permittivities of the two triboelectric layers; Δx₁, Δx₂, and ψ are the relative translational displacements along s and t axis and rotation of the two simplified planes. For angle-changing type TEGs,

$${x}_{10} = {l}_{0} ( 1 - cos ( \frac{ψ + {ψ}_{0}}{2} ) ) , {x}_{20} = {l}_{0} sin ( \frac{ψ + {ψ}_{0}}{2} ) , \\ Δ {x}_{1} = \frac{{γ}_{α} {l}_{v 0}}{2} , Δ {x}_{2} = \frac{{ε}_{α}^{⊥} {l}_{v 0}}{2} , {l}_{v 0} = {l}_{0} sin {ψ}_{0} ,$$

and Δψ=γ_{α}; for distance-changing type TEGs, x₁₀=0, x₂₀=constant,

$$Δ {x}_{1} = {γ}_{α} {l}_{v 0} , Δ {x}_{2} = {ε}_{α}^{⊥} {l}_{v 0} , Δψ = 0 , {l}_{v 0} = {l}_{0} ;$$

and for mixed type TEGs,

$${x}_{10} = {l}_{0} ( 1 - cos ( \frac{ψ + {ψ}_{0}}{2} ) ) ,$$

x₂₀=constant

$$Δ {x}_{1} = {γ}_{α} {l}_{v 0} , Δ {x}_{2} = {l}_{0} sin ( \frac{ψ + {ψ}_{0}}{2} ) + {ε}_{α}^{⊥} {l}_{v 0} , Δψ = arctan ( \frac{v tan {ψ}_{0}}{{x}_{02}} ) - {ψ}_{0} ,$$

and lᵥ₀=constant. The deformation of each layer of ST and SCT can be described by the theory of distance-changing type TEGs by considering x₁₀=0, x₂₀=constant,

$$Δ {x}_{1} = {γ}_{α} {l}_{v 0} , Δ {x}_{2} = {ε}_{α}^{⊥} {l}_{v 0} , Δψ = 0 ,$$

and lᵥ₀=4l₀. The local strain vectors γ_{α} and

$${ε}_{α}^{⊥}$$

can be derived from the domain under a uniaxial compression in y direction in FIG. 5B through the following expressions:

$${γ}_{α} = ( {ε}_{xx} - {ε}_{yy} ) sin 2 α ; \qquad ( 6 a )$$

$${ε}_{α}^{⊥} = \frac{{ε}_{xx} + {ε}_{yy}}{2} + \frac{{ε}_{xx} - {ε}_{yy}}{2} cos 2 α ; and \qquad ( 6 b )$$

$${ε}_{xx} = - v {ε}_{yy} . \qquad ( 6 c )$$

When connected in parallel, the total open-circuit voltage output of multiple TEGs is assumed to be expressed by the following equation, verified by comparing the results with the detailed finite element analysis predictions:

$${V}_{OC , parallel} = \frac{{\sum }_{k = 1}^{n} {V}_{OC , k} \vert 2 {x}_{max} - {x}_{k} \vert}{{\sum }_{k = 1}^{n} \vert 2 {x}_{max} - {x}_{k} \vert} . \qquad ( 7 )$$

All the constitutive cells were assumed to yield voltage output equally for a TMM experiencing a uniform deformation. From Equations 3 to 6 for one unit cell, the TEGs with the same α or rotational symmetry possess identical theoretical voltage output, as marked by the same number in FIG. 5D, from which a representative TEG can be determined. Therefore, the open-circuit voltage output of a TMM is equal to the overall V_{OC} of representative TEGs connected in parallel (Equation 7). To quantitatively evaluate and compare the energy harvesting performance of TEGs with alternative underlying architecture, a dimensionless electrical-structural figure-of-merit (FOMₑₛ) has is evaluated:

$${FOM}_{es} = max ( \frac{2 {ε}_{0}}{{σ}^{2}} \frac{{E}_{m}}{Ax} ) {\vert}_{x = 0 ∼ {x}_{max}} ; \qquad ( 8 )$$

where A and x are the area and the displacement of TMM in the loading direction.

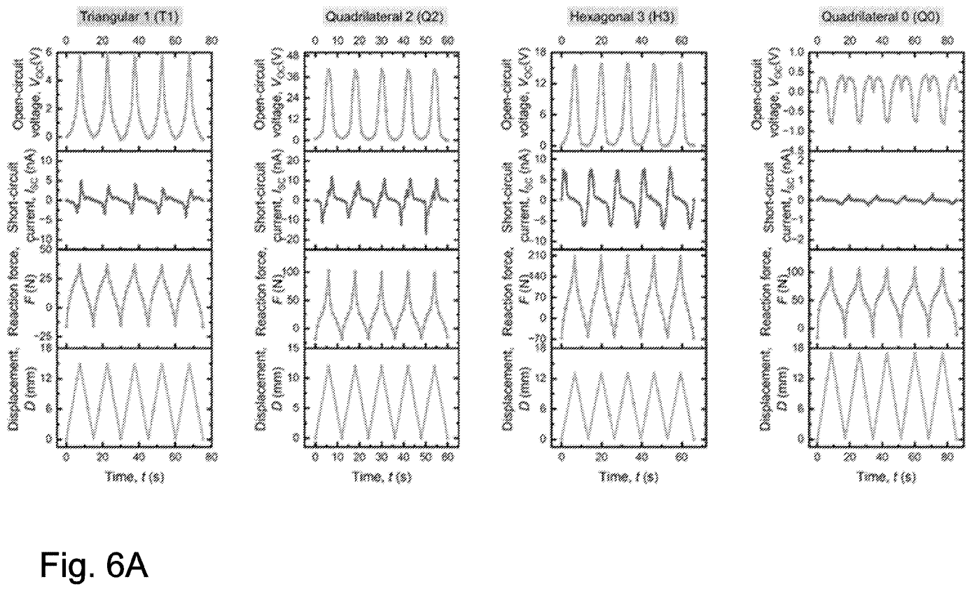

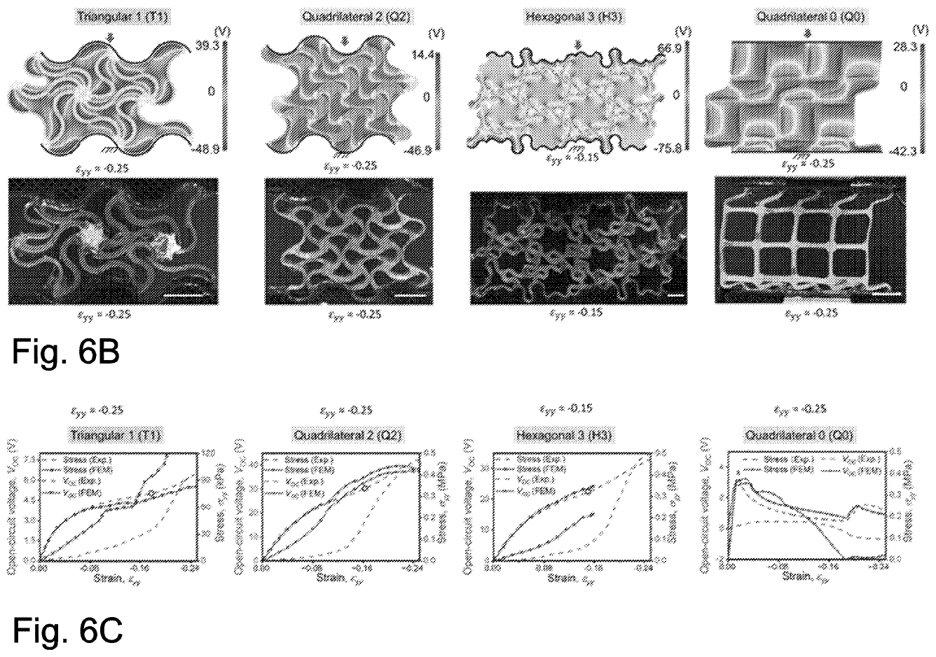

As shown in FIG. 6A, all four types of TMMs (T1, Q2, H3, and Q0) present stable mechanical and electrical performance when subjected to a uniaxial cyclic load in the experiment. Compared to conventional architectures, TMMs with curved struts (i.e., T1, Q2, and H3) can realize more remarkable open-circuit voltage (V_{OC}) and short-circuit current (I_{SC}). In specific, experimental V_{OC} and I_{SC} of Q2 surpass the corresponding performance of the triboelectric design with the conventional architecture (Q0) by 53.3 and 55.1 times, respectively. The TMM with underlying Q2 architecture presents the highest V_{OC} of approximately 40 V and the highest I_{SC} of around 10 nA. It is worth mentioning that the V_{OC} and I_{SC} are expected to be further improved by increasing the frequency of loading, which is 0.083 Hz in the present example. As presented in FIGS. 6b and 6c, when loaded until a compressive strain of ε_{yy}=−0.25, the introduced TMMs with curved architectures undergo a uniform deformation through the bending of curved struts, driving all the integrated TEGs to generate electricity synchronously from the mechanical deformation. In the meantime, the stress-strain curve of curved architected TMMs features an initial increasing trend for stress followed by a gradual decline in the slope of stress-strain curves. Then, contact electrification occurs (black circles in the stress-strain curve in FIG. 6C) at nearly all the triboelectric pairs for T1, Q2, and H3 designs before strain reaches ε_{yy}=−0.25. In comparison, the conventional architected triboelectric materials first experience a narrow elastic domain (ε_{yy}=0~−0.02) with the opposite triboelectric surfaces approaching each other in the compressive direction. Then, local buckling of cell walls in the conventional architectures triggers a layer-by-layer deformation in tandem with lateral separating motions of the triboelectric pairs at the deformed layer; the triboelectric pairs in the Q0 design hardly contact each other after buckling during the compression of triboelectric materials, resulting in a poor contact-electrified charge density. Consequently, as shown in FIG. 6C, the open-circuit voltage of Q0 increases in the elastic domain, but the lateral separating motion triggered by the in-plane buckling of the square cells reverses the increasing trend caused by approaching motion and decreases the generated voltage to negative values. Moreover, the Q2 design realizes a 19.3% improvement of SEA under a compressive strain ε_{yy}=−0.25 compared to the Q0 design. In summary, resorting to the curved architecture design can lead to the realization of TMMs with combined excellent electric output and high energy absorption capacity.

Moreover, ST and SCT are compared with Q2 and Q0 by experimentations. The ST and SCT triboelectric exhibit uniform deformation and zero Poisson's ratio during compression until ε_{yy}=−0.25. The maximum generated V_{OC} of ST and SCT designs are 0.8 V and 9.8 V, respectively, much lower than the generated voltage by Q2 design, i.e., 40 V. The developed FEM method is also validated in FIG. 6B and c where the developed numerical model can accurately predict the compressive stress-strain curves and match the trend of the V_{OC}-strain curves found in experiments. The difference between FEM and experimental results in terms of V_{OC}-strain curves is caused by the non-uniform distribution of charges on the triboelectric surfaces and the charge dissipation into the air.

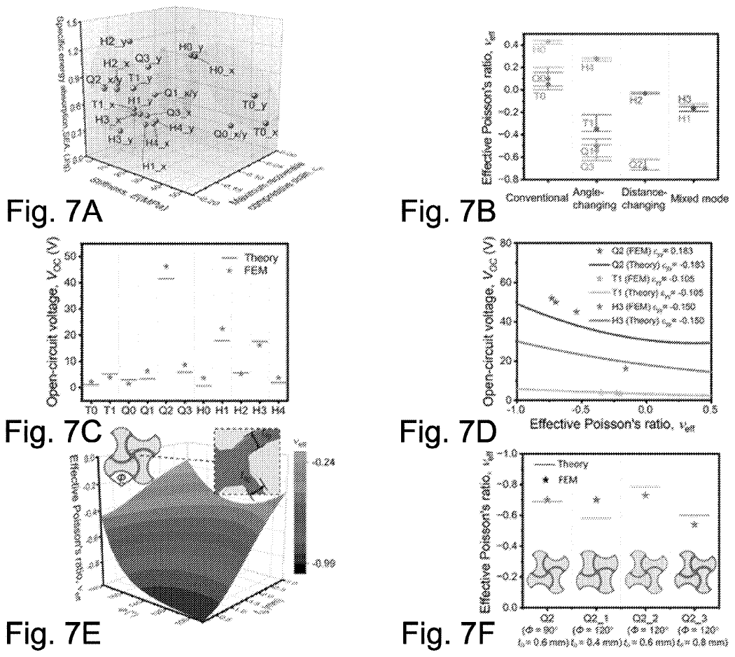

In order to investigate the relation between curved architectures and electromechanical performance, a finite element analysis is performed on all eleven TMM designs made by 4×4 cells. By tailoring the architectural parameters and adopting FEM, FIG. 7A shows how TMMs can occupy a large space in the SEA-stiffness-εₘ triboelectric material selection chart. TMM designs with curved architectures can achieve much higher ε_{yy,m} (95.1% higher compared to T0 design) but lower stiffness than those triboelectric with conventional architectures. Specifically, the Q2 design exhibits the best resilience of ε_{yy,m}=−0.183. Generally, the resilience of angle-changing type TMMs is lower than the distance-changing types. The SEA of angle-changing type and mixed-type TMM designs with curved architectures is comparable to those with conventional architectures. The distance-changing type TMMs can deliver excellent SEA and resilience simultaneously, among which H2 possesses the highest SEA as of 1.27 J/g.

The triboelectric material designs with conventional architectures (i.e., T0, Q0, and H0) feature a peak on the stress-strain curves and V_{OC}-strain curves, caused by the local buckling of cell walls followed by the change of the mode of motion of triboelectric pairs. The maximum recoverable compressive strains ε_{yy,m} for T0, Q0, and H0 designs are close to the strains of the peak stress, which are much lower than the TMM designs with curved architectures. As output open-circuit voltage increases monotonically with the compressive strain, the resilient curved architectures impart greater electric output for a larger range of strain. Generally, by introducing curved architectures, localized deformation of triangular, quadrilateral, and hexagonal cellular architecture can be fully or partially eliminated, and the TMMs can benefit from a wider range of loading strain for the generation of electricity. The effective Poisson's ratios are measured for all TMM designs using FEM for a range of strains from ε_{yy}=0 to ε_{yy,m}, as shown in FIG. 7B. It is found that the TMM designs with conventional architectures exhibit positive v_{eff}, while TMM designs with curved segments except H4 exhibit negative Poisson's ratio. Since there is no transverse deformation in ST and SCT designs, their Poisson's ratios are zero.

As compared in FIG. 7C, the theoretical predictions for V_{OC} at the maximum recoverable compressive strain ε_{yy,m} are consistent with the results of detailed finite element modelling. The Q2 design possesses the highest V_{OC} among all the TMM designs with the same relative density. It is worthwhile mentioning that due to the uniform distance-changing and angle-changing deformation of T0, Q0, and H0 design before ε_{yy,m}, these three designs can be respectively considered as angle-changing, distance-changing, and angle-changing types of TEGs in the theoretical analyses to predict their electrical output. Consequently, TO and H0 share the same form of theoretical equations and geometrical parameters (x₂₀, x₂₀, ψ₀, α, and lᵥ₀) with T1 and H4, respectively, while x₂₀ is the only difference between Q0 and Q2.

To derive generalized conclusions on the relationship between FOMₑₛ and alternative architecture designs, the following assumptions have been made to generalize the theoretical model: (1) By varying the shape, curvature, and thickness of the TMM cell walls while keeping the position of nodes connecting the struts unchanged, a group of TMM variants with a wide range of v_{eff} from −1 to 0.5 can be realized and can bear ε_{yy,m} from 0 to −0.25; (2) The length of the triboelectric surface l₀ is equal to a for Q0 and Q2 designs, and it is a/2 for the other TMMs when the chamfers of the adjacent cell walls and the volume of strut nodes are neglected. As shown in FIG. 7D, theoretical analyses verified by FEM unravel the effects of Poisson's ratio on the generated voltage of TMM designs with T1, Q2, and H3 architectures. For Q2 design, V_{OC} decreases with the increase of v_{eff} from −1 to 0.33 and grows slowly for architectures with higher v_{eff}=0.33; for T1 and H3 designs, V_{OC} shows a monotonic decreasing trend with Poisson's ratio. An example of achieving a wide range of v_{eff} by changing the architectural parameters is presented in FIG. 7E for Q2 design that shows a variation of Poisson's ratio between −0.12 to −0.98. For the sake of comparison, v_{eff} for four variants of Q2 designs, based on theoretical modelling and FEM, is presented in FIG. 7F. For other TMMs, similar analytical modelling can be developed to investigate the influence of geometric parameters on v_{eff}.

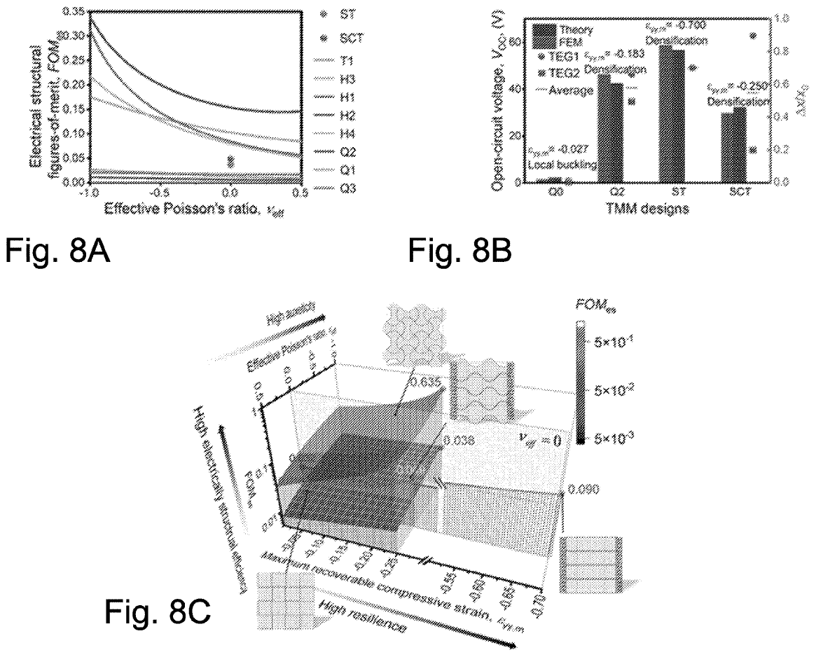

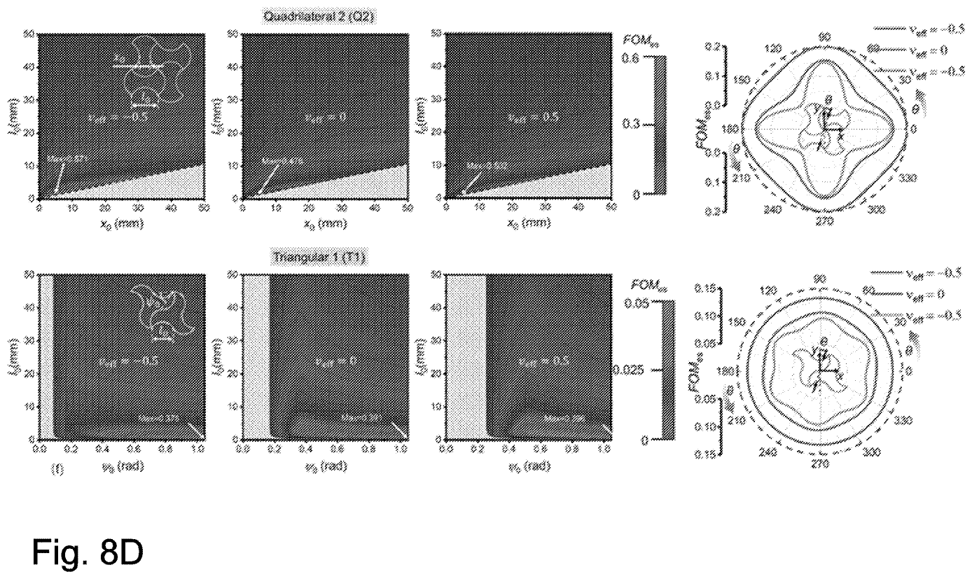

The electrical-structural figure-of-merit for eight TMM groups with curved struts under a uniaxial strain ε_{yy}=−0.21 are calculated by utilizing the developed theoretical model and compared in FIG. 8A where the effects of v_{eff} on the FOMₑₛ is also explored. The FOMₑₛ values for the majority of architectural groups are significantly enhanced by their auxeticity. The Q2 architecture exhibits the highest FOMₑₛ for the whole range of Poisson's ratio, reaching the maximum value of 0.339 for FOMₑₛ at the lowest v_{eff}. The T1, H1, and H3 architectures also show FOMₑₛ values close to that of Q2 architecture. As T1 has the highest area of triboelectric surfaces per volume, its FOMₑₛ is not less than 50% of that of Q2 TMM as shown in FIG. 8A, even though its V_{OC} is only 15.4% of V_{OC} of Q2 TMM, as depicted in FIG. 7C. In comparison, the FOMₑₛ of conventional plate-like and multi-layered TEGs ST and SCT are only 25.0% and 21.6% of the Q2 architecture when ε_{yy}=−0.21 and v_{eff}=0; hence, FOMₑₛ of Q2 design can surpass those of stacked triboelectric devices by at least three times; ST and SCT needs to be compressed much greater to be able to offer comparable V_{OC} to the Q2 architecture, as shown in FIG. 8B. This figure also reveals that the generated V_{OC} is highly dependent on the average Δx/x₀ of the TEGs forming the triboelectric metamaterials. Considering the variable values of ε_{yy}, FIG. 8C compares the performance of Q0, Q2, ST, and SCT designs with the same l₀=12 mm when v_{eff}=−1~0.5 and ε_{yy}=0~−0.25; in this condition the Q2 designs can realize a FOMₑₛ as high as 0.635 when ε_{yy}=−0.25 and v_{eff}=−1, which is 16.4 times higher than the maximum FOMₑₛ that is achievable by Q0 design. Compared to Q0 group, ST, and SCT, and Q2 designs show the highest FOMₑₛ throughout a wide range of compressive strain ε_{yy}=0~−0.25. It is worth mentioning that even though a wide range of compressive strain is presented for the Q0 design, this design tends to fail by local buckling at a small compressive strain, as demonstrated by numerical simulation in FIG. 8B. Consequently, Q2 architecture is the optimal choice for TMMs considering its remarkable FOMₑₛ, high resilience, and wide range of v_{eff}.

Selecting Q2 and T1 architectures as representatives of distance-changing and angle-changing TMMs, the effects of critical geometric parameters on the FOMₑₛ can be evaluated by conducting a theoretical analysis. For Q2 design, critical parameters, including the effective distance between the opposite triboelectric surfaces x₀ and the length of the cell wall l₀ are considered, while the angle between the opposite triboelectric surfaces ψ₀ and l₀ are considered for the T1 architecture. The analytical results impart design strategies for these two categories of TMMs, as shown in FIG. 8D. To realize maximum FOMₑₛ for the Q2 architecture, l₀ should be small that indicates decreasing the unit cell size is beneficial for attaining a higher electrical and structural efficiency. Meanwhile, x₀/l₀ for Q2 design should be as small as possible. As a result, Q0 with x₀/l₀=1 is anticipated to possess lower FOMₑₛ than the Q2 design with x₀/l₀=0.272. For reaching the maximum FOMₑₛ in T1 design, l₀ should be small while ψ₀ should be as large as possible. FIG. 8D also reveals that variation of v_{eff} affects the maximum values of FOMₑₛ but does not affect the above-mentioned conclusions. The anisotropy of FOMₑₛ of T1 and Q2 TMMs is also investigated, as shown in FIG. 8D where the variation of FOMₑₛ with the loading direction θ is also determined. Both T1 and Q2 architectures exhibit a more isotropic behaviour for FOMₑₛ when v_{eff} decreases.

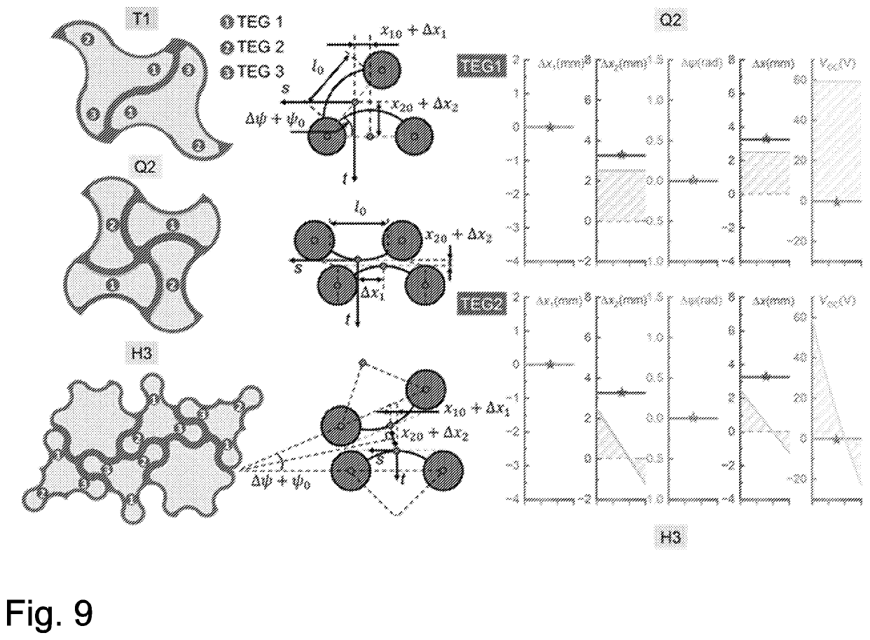

To understand the underlying mechanisms leading to the variation of FOMₑₛ with Poisson's ratio, the correlation among FOMₑₛ, V_{OC} of each TEG, and deformation vectors of each TEG is investigated for various v_{eff}. FIG. 9 shows theoretical predictions for the relationships between five parameters (Δx₁, Δx₂, Δψ, Δx, and V_{OC}) of TEGs for alternative orientations and V_{eff}. For the Q2 design, the V_{OC} of TEG1 remains constant when V_{eff} increases, while the V_{OC} of TEG2 decreases, resulting in a decreasing trend for the overall V_{OC} in FIG. 7D. As a distance-changing mode TMM, it is assumed that the distance-related vectors (Δx₁, Δx₂) play critical roles in the electrical output; V_{OC} is also highly dependent on the equivalent displacements Δx. Therefore, the following trending chain is assumed for TEG2 of Q2 design: v_{eff}⬇→Δx₂⬆→Δx⬆→V_{OC}⬆ and demonstrated in FIG. 9; identical trends of v_{eff}, Δx₂, Δx, and V_{OC} versus various v_{eff} are observed for the associated TEG1. For an angle-changing mode TMM (for example, T1 design), both TEG 1 and TEG 2 show little variation of V_{OC} for alternative v_{eff}. The decreasing trend of the overall V_{OC} with v_{eff} is highly consistent with the trend of TEG 3 with α=240°, the orientation of which is the closest to the loading direction among all three orientations of TEGs in the T1 design. By observing the relationship among the above-mentioned parameters, the dominant mechanisms are concluded as follows for the T1 design.

$$\{ \begin{matrix}{v}_{eff} ↑ \to Δψ ↑ \to Δ x ↑ \to {V}_{OC} ↑ & ( Δψ > 0 ) \\ {v}_{eff} ↑ \to Δψ ↓ \to Δ x ↓ \to {V}_{OC} ↓ & ( Δψ < 0 )\end{matrix} ; \qquad ( 9 )$$

where Δψ⬆→Δx⬆ is a unique dominant mechanism distinguished from the distance-changing mode TMMs (for example, Q2 design). For mixed-mode TMMs, both the dominating mechanism in distance-changing (v_{eff}⬇→Δx₂⬆) and angle-changing mode (Δψ⬆→Δx⬆TMMs exist, as shown in the H3 group graphs in FIG. 9. Therefore, for distance-changing mode TMMs, the dominating geometric parameter of FOMₑₛ is Δx₂/x₂₀. When Δx₂/x₂₀ increases, the FOMₑₛ is enhanced significantly; While for angle-changing mode TMMs, the dominating parameter is Δψ/ψ₀. The FOMₑₛ increases with Δψ/ψ₀. For mixed-mode TMMs, both the dominating mechanism in distance-changing and angle-changing mode TMMs exist. The architectures featuring higher value of the dominating geometric parameter can achieve higher FOMₑₛ. Even though all TEGs in the H3 design show decreasing trends of V_{OC} versus v_{eff}, the voltage output of TEG1 with α=900 experiences the most drastic drop by increasing v_{eff}. Moreover, it is generally found that the TEGs with orientations close to 90° or 270°, aligned with the loading direction, yield the lowest V_{OC} among all the TEGs that drop the total generated output voltage of the TMMs. These findings indicate that the relationship between the overall V_{OC} and v_{eff} is strongly dependent on the corresponding behaviour of TEGs with angle orientation close to the loading direction. Furthermore, for all three modes of TMMs, a higher Δx/x₀ results in a higher V_{OC}, which is consistent with the conclusion from FIG. 8B.

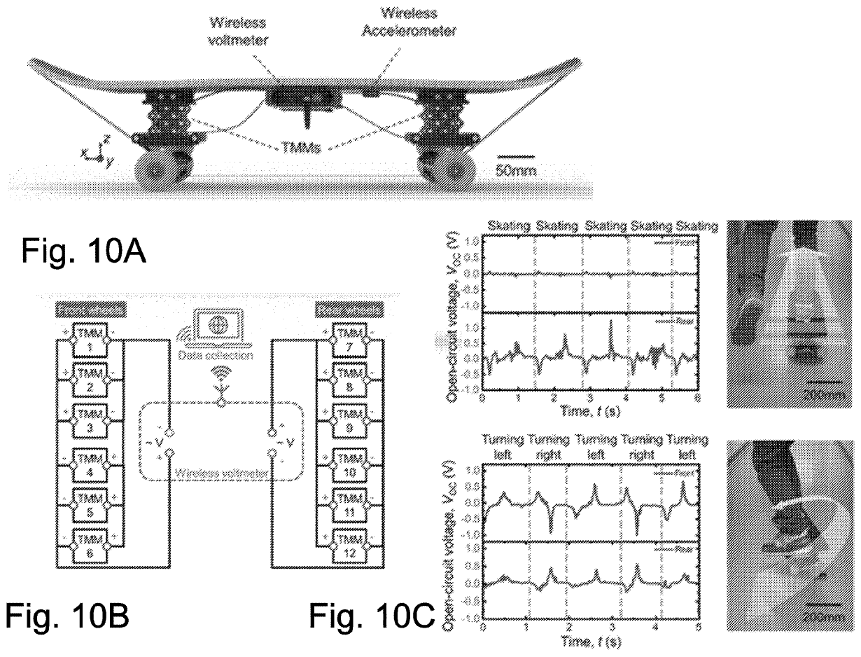

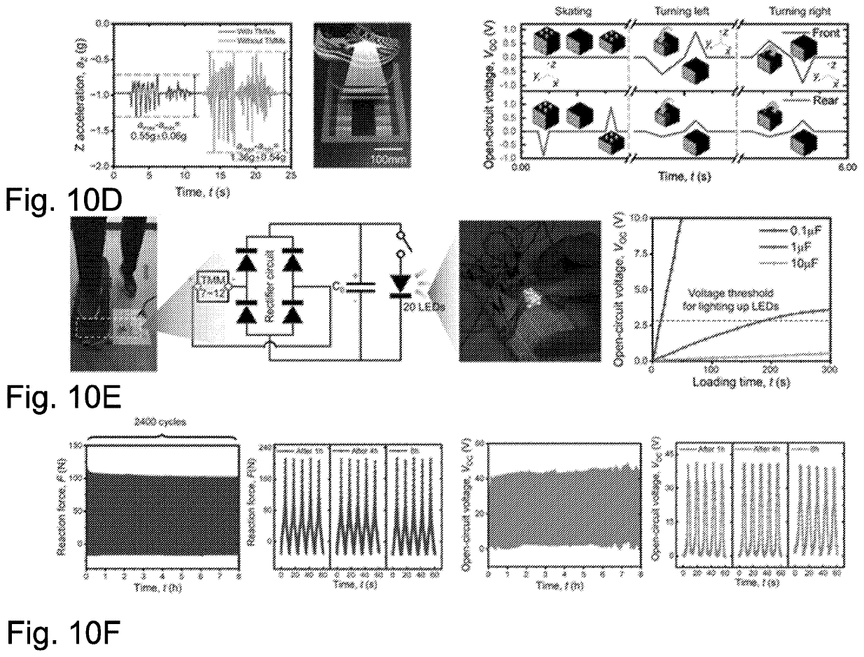

To demonstrate the advantages of TMMs including the simultaneous high energy absorption and sensing capabilities for detecting and scavenging energy from small deformation, a daily-life application of TMMs in the form of an intelligent skateboard is fabricated out of Q2 architecture as shown in FIG. 10A (schematic graph) and experimentally tested under various skateboarding motions; Q2 design has been selected for fabrication since the design has been demonstrated (FIG. 7A) to possess combined excellent mechanical properties (i.e., stiffness, resilience, and SEA) and maximum electrical-structural figure-of-merit (also the highest power density) among the designs of architected triboelectrics explored in this example. Two groups of TMMs, each containing six triboelectrics of Q2 architecture are connected as presented in FIG. 10B and are integrated into the front and rear skateboard trucks separately. The output voltage of the left (TMM 1~3) and right (TMM 4~6) TMM subgroups at the front of the skateboard differ from each other, reflecting the fact that the compressive displacements of these subgroups also differ when the skateboard is turned left or right; the rear group of TMMs outputs the summation of voltages of TMM 7~12, presenting the loading amplitude in the z direction. A wireless voltmeter Hantek IDSO 1070A is used to remotely transfer the open-circuit voltage outputs to a receiver. The TMMs in the front and rear trucks can independently generate voltage outputs regarding the roll and compression of the skateboard, which can sense human motions, including skating, turning left, and turning right, when their V_{OC}-time curves are combined. As shown in FIG. 10C, when a skateboarder rider pushes on the skateboard to move it forward, the exerted force results in simultaneous deformation of the front and rear TMM groups. Both TMM groups undergo compression and a subsequent rebound from the compression in z direction, resulting in a sharp peak and valley of the voltage outputs for the rear group, while the front group present no voltage fluctuation since the voltage output difference of TMM 1~3 and 4~6 is zero. When the skateboarder turns left, there is a rotation of the skateboard around x-axis, and both the front and rear TMM groups undergo a tilt around x-axis. The difference in compressive deformation between TMMs 1~3 and 4~6 results in a valley followed by a peak on the V_{OC}-time curve. Note that the TMMs 7~12 still generate V_{OC} signals during turning but not as significant as those from TMMs 7~12, as the rear TMMs experience weaker compression and rebound compared to skating forward.

The fabricated intelligent skateboard shows great shock absorption capability in tandem with motion detection. The shock absorption feature of TMMs is evaluated by the maximum acceleration in z direction (a_{z}) when the skateboard passes a washboard road with a velocity of 0.5 m/s. As shown in FIG. 10D, the intelligent skateboard can reduce a_{z} by 59.5% compared to a design without the utilization of TMMs. The shock energy is dissipated by the viscous and plastic characteristics of TMMs, as presented in FIG. 4. As a demonstration of the energy harvesting capability, the intelligent skateboard is loaded by continuously stepping on to first charge a capacitor and then lighten up 20 LEDs. As shown in FIG. 10E, with three different capacitances, the voltage across the capacitor increases nonlinearly with the loading time, and the speed of charging decreases gradually until it reaches the voltage threshold of 3.0 V. As experimented, a 1 μF capacitor can be charged to the voltage threshold in 4 minutes to lighten up 20 LEDs. The damage-tolerant mechanical performance and the stability of electrical output of Q2 TMMs during a long service life are demonstrated by the stable amplitudes of electrical (i.e., open-circuit voltage) and mechanical (i.e., reaction force) responses after conducting an eight-hour continuous cyclic loading experiment, as shown in FIG. 10F.

In summary, a new triboelectric mechanical metamaterial with horseshoe underlying architectures is presented. By distributing a tribo-pair on two opposite surfaces within a unit cell, the introduced TMMs harvest electricity from the local strain-induced mechanical energy. Exploring the local motions of tribo-pairs integrated in the cellular architectures, three working modes of TMMs (i.e., angle-changing, distance-changing, and mixed mode) are identified. TMM samples are fabricated by utilizing additive manufacturing and film adhesion techniques. FEM models are developed to study the underlying mechanisms associated with the remarkable electromechanical performance of TMMs. Experimental and numerical results unravel the role of curved struts in facilitating contact electrification and resisting non-uniform deformation, as well as realizing a remarkable combination of high resilience, SEA, and auxeticity. Moreover, the developed TMMs exhibit significantly higher V_{OC} and I_{SC} compared to the conventionally architected triboelectric materials and stacked TEGs with flat or curved structures. The Q2 design of TMM shows extremely high V_{OC} and I_{SC} among all the designed TMM designs, 53.3 times and 55.1 times higher than those for the Q0 design, respectively. By tailoring the topological design, a wide space for the stiffness, resilience, SEA, and Poisson's ratio of triboelectric metamaterials can be achieved. The distance-changing type TMMs can achieve remarkable SEA and resilience simultaneously. Moreover, the developed TMMs effectively harvest energy under compressive loads exerted along multiple directions.

A theoretical model for the energy harvesting characteristics of TMMs is established to elicit the influence of Poisson's ratio, critical geometric parameters, and loading strains on the electrical-structural figure-of-merit. The theory, for the first time, renders a reliable strategy for analyzing the electric output of TMMs by taking into account alternative working modes of triboelectrics, simplifying the shape of curved struts, and discovering the relationship between the overall energy harvesting straits of the TMMs and each of the generated voltage/current of constitutive tribo-pairs that may possess distinctive displacement. Based on the theory, the FOMₑₛ of TMMs can be accurately tailored given that the relationship of geometric parameters—Poisson's ratio—FOMₑₛ is quantitatively revealed. The theoretical analysis reveals how the uniform deformation and auxetic behaviour of cellular architecture enhance the electrical output through synchronizing the open-circuit voltage of different TEGs. It is found that the overall open-circuit voltage of TMMs is governed by the deformation mode and auxeticity of TEGs oriented in the loading directions. The lower negative Poisson's ratio leads to enhanced local deformations and higher V_{OC} of these TEGs, resulting in a higher overall V_{OC} of the TMM. The overall FOMₑₛ is affected by the TMM working modes, TEG orientations, and the area of triboelectric surfaces (or the number of TEGs) per volume which are determined by the topology of TMMs. Design strategies for the geometric parameters are proposed for distance-changing and angle-changing TMMs. A daily-life application is demonstrated for utilizing the shock-absorbing and load-bearing capabilities of TMMs to realize a multifunctional intelligent skateboard that converts the wasted mechanical energy into electrical sensing signals associated with the skateboard motion modes and into electricity for lighting 20 LEDs mounted on the board. Nevertheless, the electrical performance of TMMs can be further improved when advanced material modification technologies are introduced into the current architecture design in future research. The potential technologies include physical, chemical, biological, or hybrid modification of triboelectric surfaces, artificial injection of ions, and surface polarization from ferroelectric materials. The benefits of structural optimization accomplished in this example will be magnified by material improvements to better contribute to overall electrical performance. In future research, humidity-resistant curved architected TMMs can be further developed by combining the current topology and TEG distributing designs and recently reported humidity resistant design strategies including packaging technique, triboelectric surface morphology modification, or special structural design of TEGs. This research imparts a framework for developing the next generation of lightweight architected triboelectrics serving as self-powered sensors, self-sensing materials, and multifunctional energy harvesters.

In another aspect of the present disclosure, there is described a method of generating a flow of electric charges using a triboelectric device such as the ones described above. At a first step, the triboelectric circuit provides a first electrode assembly snugly covering the first curved surfaces, and a second electrode assembly snugly covering the second curved surfaces. At a second step, the resilient structure electrically insulates the first and second electrode assemblies electrically insulated from one another. The insulation can come from the resilient structure being made of an electrically insulating material, or from the construction of the first and second electrode assemblies. At a third step, while deforming the resilient structure along the deformation plane, a flow of electric charges is created across the triboelectric circuit. It is noted that the deformation forces the movement of the first and second curved surfaces of the hollow cells relative to one another which is the basis of the triboelectric effect of the triboelectric device described herein. In some embodiments, the resilient structure is auxetic. In other words, the resilient structure becomes thicker perpendicular to an exerted deformation force when stretched and/or becomes thinner perpendicular to the exerted deformation force when compressed. In some other embodiments, the triboelectric device includes a controller having a processor and a non-transitory memory having stored thereon instructions which when executed by the processor perform the steps of: determining an amplitude and/or a direction of the deformation of the resilient structure based on the created flow of charges.

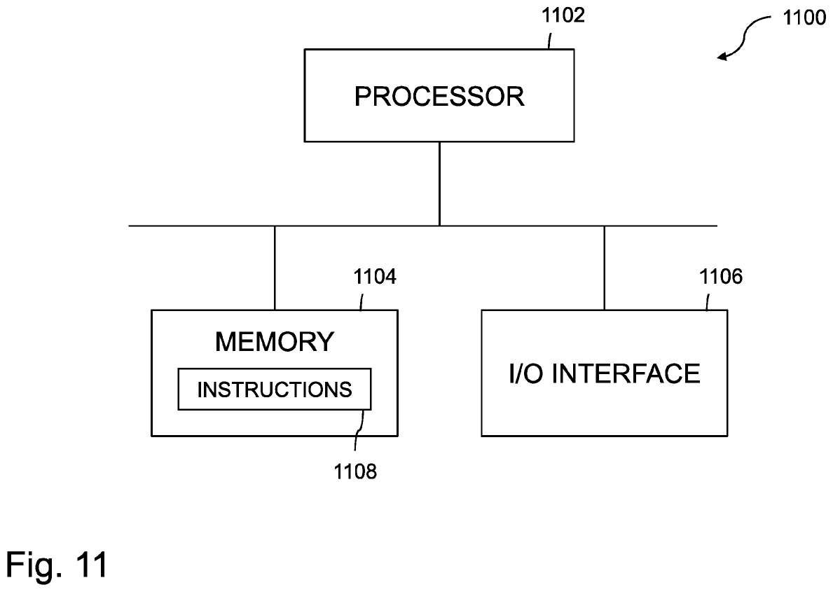

Referring now to FIG. 11, such controller can be provided as a combination of hardware and software components. The hardware components can be implemented in the form of a computing device 1100, an example of which is described with reference to FIG. 11. The computing device 1100 can have a processor 1102, a memory 1104, and I/O interface 1106. Instructions 1108 for handling the flow of electric charges, or data derived therefrom, can be stored on the memory 1104 and accessible by the processor 1102.

The processor 1102 can be, for example, a general-purpose microprocessor or microcontroller, a digital signal processing (DSP) processor, an integrated circuit, a field-programmable gate array (FPGA), a reconfigurable processor, a programmable read-only memory (PROM), a programmable logic controller (PLC), or any combination thereof.

The memory 1104 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1106 enables the computing device 1100 to interconnect with one or more input devices, such as one or more triboelectric device(s), keyboard(s), mouse(s), or with one or more output devices such as display(s), electrical device(s) such as lamp(s) or capacitor(s), an external network or an accessible memory.

Each I/O interface 1106 enables the controller to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fibre optics, satellite, mobile, wireless (e.g., Wi-Fi, WiMAX), SS7 signaling network, fixed line, local area network, wide area network, and others, including any combination of these.

The computing device 1100 and any software application that can be run by the computing device 1100 are meant to be examples only. Other suitable embodiments of the controller can also be provided, as it will be apparent to the skilled reader.

In another aspect of the present disclosure, there is described a vehicle incorporating one or more triboelectric devices. For instance, the vehicle can have a body, a displacement mechanism, and triboelectric device interfacing the body to the displacement mechanism. The triboelectric device generally has a resilient structure connecting the body to the displacement mechanism. The resilient structure has a deformation plane intersecting with the body and the displacement mechanism in some embodiments. The resilient structure has hollow cells having internal walls having a cross-sectional shape extending along a respective cell axis perpendicular to the deformation plane. The internal walls defining a cavity thereinside, and has first and second curved surfaces distributed around the cavity and facing the cavity. The triboelectric device has a triboelectric circuit having a first electrode assembly covering the first curved surfaces, a second electrode assembly covering the second curved surfaces, the first and second electrode assemblies electrically insulated from one another. Depending on the embodiment, the vehicle can be provided in the form of a skateboard, wheel skates, a bicycle, a moped and any other suitable vehicle. The displacement mechanism can be wheeled in some embodiments. In some other embodiments, the displacement mechanism can include skis, tracks or any other displacement mechanism as the embodiment may dictate.

As can be understood, the examples described above and illustrated are intended to be exemplary only. For instance, the first electrode assembly can cover a third curved surface of the internal wall, and the second electrode assembly can cover a fourth curved surface of the internal wall. In these embodiments, the first, second, third and fourth curved surfaces are distributed around the cavity, facing the cavity and interspersed with one another. The scope is indicated by the appended claims.

1. A triboelectric device comprising:
a resilient structure having a deformation plane, and a plurality of hollow cells having internal walls having a cross-sectional shape extending along a respective cell axis perpendicular to the deformation plane, the internal walls defining a cavity thereinside, and having first and second curved surfaces distributed around the cavity and facing the cavity; and
a triboelectric circuit having a first electrode assembly covering the first curved surfaces, a second electrode assembly covering the second curved surfaces, the first and second electrode assemblies electrically insulated from one another;
wherein, when the resilient structure is deformed along the deformation plane, the first and second electrode assemblies perform a movement relative to one another thereby creating a flow of electric charges across the triboelectric circuit.

2. The triboelectric device of claim 1 wherein the first and second curved surfaces differ in circumferential positioning from one hollow cell to another.

3. The triboelectric device of claim 1 wherein the resilient structure is auxetic.

4. The triboelectric device of claim 1 wherein the relative movement of the first and second electrode assemblies includes a rotational movement.

5. The triboelectric device of claim 1 wherein the resilient structure has a first lateral side exposing first openings of the hollow cells, and a second lateral side exposing second openings of the hollow cells, the second openings opposite to the first openings.

6. The triboelectric device of claim 5 wherein the first electrode assembly having a plurality of first flaps inserted into the hollow cells via the first openings and the second electrode assembly having a plurality of second flaps inserted into the hollow cells via the second openings.

7. The triboelectric device of claim 1 wherein the first and second electrode assemblies have an electrically conductive layer and an electrically insulating layer covering the electrically conductive layer, the electrically insulating layers of the first electrode assemblies facing the electrically insulating layers of the second electrode assemblies across the cavities.

8. The triboelectric device of claim 7 wherein the electrically insulating layer of the first electrode assembly is made of a first electrically insulating material, and the electrically insulating layer of the second electrode assembly is made of a second electrically insulating material different from the first electrically insulating material.

9. The triboelectric device of claim 8 wherein the first electrically insulating material is polyethylene terephthalate (PET) and the second electrically insulating material is polytetrafluoroethylene (PTFE).

10. (canceled)

11. The triboelectric device of claim 1 wherein the hollow cells are arranged in a tessellation made integral to the resilient structure.

12. The triboelectric device of claim 1 wherein the resilient material made of polypropylene (PP).

13. The triboelectric device of claim 1 wherein the first and second electrode assemblies are laminated onto a respective one of the first and second curved surfaces.

14. The triboelectric device of claim 1 wherein the first electrode assembly covers a third curved surface of the internal wall, and the second electrode assembly covers a fourth curved surface of the internal wall, and wherein the first, second, third and fourth curved surfaces are distributed around the cavity, facing the cavity and interspersed with one another.

15. The triboelectric device of claim 1 wherein the cross-sectional shape is selected from a group consisting of: a triangular-like shape, a circular-like shape, an ovoid-like shape, a quadrilateral-like shape, a hexagonal-like shape, and a horseshoe-like shape.

16. The triboelectric device of claim 1 wherein the flow of charges is indicative of at least one of an amplitude and a direction of the deformation imparted on the resilient structure in the deformation plane.

17. (canceled)

18. A method of generating a flow of electric charges using a triboelectric device, the triboelectric device having a resilient structure having a deformation plane, and a plurality of hollow cells having internal walls having a cross-sectional shape extending along a respective cell axis perpendicular to the deformation plane, the internal walls defining a cavity thereinside, and having first and second curved surfaces distributed around the cavity and facing the cavity, the method comprising:
a triboelectric circuit providing a first electrode assembly snugly covering the first curved surfaces, and a second electrode assembly snugly covering the second curved surfaces;
the resilient structure electrically insulating the first and second electrode assemblies electrically insulated from one another; and
while deforming the resilient structure along the deformation plane, said deforming including moving the first and second curved surfaces of the hollow cells relative to one another, creating a flow of electric charges across the triboelectric circuit.

19. The method of claim 18 wherein the first and second curved surfaces differ in circumferential positioning from one hollow cell to another.

20. The method of claim 18 wherein the resilient structure is such that said deforming causes the resilient structure to become thicker perpendicular to an exerted deformation force when stretched and to become thinner perpendicular to the exerted deformation force when compressed.

21. (canceled)

22. A vehicle comprising: a body, a displacement mechanism, and a resilient structure connecting the body to the displacement mechanism, the resilient structure having a deformation plane intersecting with the body and the displacement mechanism; a plurality of hollow cells having internal walls having a cross-sectional shape extending along a respective cell axis perpendicular to the deformation plane, the internal walls defining a cavity thereinside, and having first and second curved surfaces distributed around the cavity and facing the cavity; and a triboelectric circuit having a first electrode assembly covering the first curved surfaces, a second electrode assembly covering the second curved surfaces, the first and second electrode assemblies electrically insulated from one another.

23. The vehicle of claim 22 wherein the first and second curved surfaces differ in circumferential positioning from one hollow cell to another.
